(19) United States
(12) Patent Application Publication
(10) Pub. No.: US 2018/0236626 A1
(43) Pub. Date: Aug. 23, 2018

(54) POLISHING HOLDER MOUNTING JIG AND OPTICAL FIBER FERRULE POLISHING HOLDER

(71) Applicant: SEIKOH GIKEN Co., Ltd., Matsudo-shi (JP)

(72) Inventor: Yuji SHIBUTANI, Matsudo-shi (JP)

(21) Appl. No.: 15/828,444

(22) Filed: Dec. 1, 2017

(30) Foreign Application Priority Data
Feb. 20, 2017 (JP) 2017-029160

(51) Int. Cl. B24B 19/22; G02B 6/46

(52) U.S. Cl. CPC B24B 19/226; G02B 6/46

(57) ABSTRACT

A polishing holder mounting jig 10 is configured to mount an optical fiber ferrule polishing holder 50 to a mounting shaft 104 of an optical fiber ferrule polishing machine 103 when the mounting shaft 104 of the optical fiber ferrule polishing machine 103 is inserted into an insertion space of an insertion pipe 12, the exposed end portion 36 is moved gradually outward in a radial direction along a tip inclined face 108 against a biasing force of a coil spring 15, the exposed end portion 36 is slid on an outer peripheral surface of the mounting shaft 104 until the exposed end portion 36 reaches a central recess 109, and the exposed end portion 36 is moved inward in the radial direction toward the central recess 109 by the biasing force of the coil spring 15 until the exposed end portion 36 is exposed to the central recess 109.

### CROSS-REFERENCES TO RELATED APPLICATIONS

This patent specification is based on Japanese patent application, No. 2017-029160 filed on Feb. 20, 2017 in the Japan Patent Office, the entire contents of which are incorporated by reference herein.

### BACKGROUND OF THE INVENTION

### 1. Field of the Invention

The present invention relates to a polishing holder mounting jig for attaching an optical fiber ferrule polishing holder to an optical fiber ferrule polishing machine, and also relates to the optical fiber ferrule polishing holder used for polishing the optical fiber ferrules.

### 2. Description of the Related Art

Patent Document 1 discloses an optical fiber ferrule polishing holder comprised of: a holder plate; seats; and supporting walls, wherein the holder plate has a plurality of ferrule insertion holes into which a plurality of optical fiber ferrules is inserted, the seats have a wall surface spaced at a predetermined distance from the insertion holes, the seats extend along one side of the insertion holes, and the supporting wall of the insertion holes is located on an opposite side of the seats, and the supporting wall vertically extends from the insertion holes. The seats have a holding member which can slide on the seats in a direction for adjusting the interval between the holding member and the supporting wall of the insertion holes. In addition, the holding member has a holding portion at the front face of the holding member confronting the supporting wall and an inclined face at the rear of the holding member, the inclined face being parallel to the wall surface of the seats and inclined down toward the wall of the seats. Furthermore, a bolt and washer for pressing downward a rod member arranged on the inclined face of the holding member of the seats is provided on the seats at an outside of the wall surface. When the bolt is tightened downwardly, the washer presses the rod member downwardly, the rod member descends along the wall surface of the seats, and the holding member is pushed forward. Thereby the optical fiber ferrule is clamped between the holding portion and the supporting wall. The optical fiber ferrule polishing holder disclosed in Patent Document 1 is attached to an optical fiber ferrule polishing machine in a state where each optical fiber ferrule is held by the holding portion and the supporting wall, and then used to polish the optical fiber ferrules.

[Patent Document 1] Japanese Patent Application Laid-Open No. 2004-181608

### BRIEF SUMMARY OF THE INVENTION

As one example to attach the optical fiber ferrule polishing holder to the optical fiber ferrule polishing machine (shown in FIG. 15), a polishing holder mounting jig is used. The polishing holder mounting jig comprises an attaching plate attached to the holder plate of an optical fiber ferrule polishing holder, an insertion pipe extending in a vertical direction from the attaching plate, a screw hole penetrating a peripheral wall of the insertion pipe in a radial direction, and a fixing screw screwed to the screw hole.

In order to attach the optical fiber ferrule polishing holder to the optical fiber ferrule polishing machine using the polishing holder mounting jig, an installation shaft of the optical fiber ferrule polishing machine is inserted into an insertion space of the insertion pipe and then the fixing screw is screwed to the screw hole penetrating the peripheral wall of the insertion pipe. When the fixing screw is rotated in the clockwise direction, the fixing screw is moved inward in a radial direction through the screw hole of the insertion pipe, a tip of the fixing screw is exposed from an inner peripheral surface of the insertion pipe to the insertion space, and then the tip of the fixing screw is exposed toward a central recess of the mounting shaft of the optical fiber ferrule polishing machine. In this way, the insertion pipe is attached to the mounting shaft, and the optical fiber ferrule polishing holder is attached to the optical fiber ferrule polishing machine.

To remove the optical fiber ferrule polishing holder from the optical fiber ferrule polishing machine, the fixing screw is rotated in the counterclockwise direction. When the fixing screw is rotated in the counterclockwise direction, the fixing screw is moved outward in the radial direction through the screw hole of the insertion pipe. The tip of the fixing screw is moved (moved back) from the inner peripheral surface of the insertion pipe, and the tip of the fixing screw is retreated from the central recess of the mounting shaft of the optical fiber ferrule polishing machine. In this state, the mounting shaft of the optical fiber ferrule polishing machine is removed from the insertion space of the insertion pipe.

Accordingly, the optical fiber ferrule polishing holder can be attached to the optical fiber ferrule polishing machine by rotating the fixing screw in the clockwise direction. The optical fiber ferrule polishing holder can be removed from the optical fiber ferrule polishing machine by rotating the fixing screw in the counterclockwise direction. However, this configuration requires the operation of rotating the fixing screw to attach the optical fiber ferrule polishing holder to the optical fiber ferrule polishing machine and remove the optical fiber ferrule polishing holder from the optical fiber ferrule polishing machine. Thus, labor and time are required to attach the optical fiber ferrule polishing holder to the optical fiber ferrule polishing machine and remove the optical fiber ferrule polishing holder from the optical fiber ferrule polishing machine. Eventually, it is difficult to quickly and easily attach the optical fiber ferrule polishing holder to the optical fiber ferrule polishing machine, and also it is difficult to quickly and easily remove the optical fiber ferrule polishing holder from the optical fiber ferrule polishing machine.

The purpose of the present invention is to provide a polishing holder mounting jig capable of quickly and easily attaching the optical fiber ferrule polishing holder to the optical fiber ferrule polishing machine and capable of quickly and easily removing the optical fiber ferrule polishing holder from the optical fiber ferrule polishing machine without requiring labor and time to attach the optical fiber ferrule polishing holder to the optical fiber ferrule polishing machine and remove the optical fiber ferrule polishing holder from the optical fiber ferrule polishing machine. Another purpose of the present invention is to provide an optical fiber ferrule polishing holder which can be quickly and easily attached to the optical fiber ferrule polishing machine and which can be quickly and easily removed from the optical fiber ferrule polishing machine without requiring labor and time.

The first precondition of the present invention to solve the above problems is a polishing holder mounting jig for detachably attaching an optical fiber ferrule polishing holder used to polish an optical fiber ferrule to an optical fiber ferrule polishing machine.

In the first precondition of the present invention, a polishing holder mounting jig comprises: an attaching plate attached to a holder plate of the optical fiber ferrule polishing holder; an insertion pipe having an insertion space for enabling to removably insert a mounting shaft of an optical fiber ferrule polishing machine, the insertion pipe extending in a vertical direction from the attaching plate; an operating rod inserted into a through hole penetrating a peripheral wall of the insertion pipe in a radial direction, the operating rod extending outward in the radial direction from the insertion pipe; and a coil spring for biasing the operating rod inward in the radial direction of the insertion pipe, wherein the operating rod comprises; an exposed end portion exposed to the insertion space from an inner peripheral surface of the insertion pipe by a biasing force of the coil spring; and a handle shaft for moving the exposed end portion outward in the radial direction from the insertion space of the insertion pipe against the biasing force of the coil spring, the handle shaft being connected with the exposed end portion and extending outward in the radial direction from the exposed end portion.

In an example of the polishing holder mounting jig of the present invention, a mounting shaft of the optical fiber ferrule polishing machine has a tip inclined face inclining from the tip of the mounting shaft toward a rear side in an axial direction and a central recess spaced apart from the tip inclined face and extending toward the rear side in the axial direction, the central recess being recessed inward in the radial direction of the mounting shaft. The polishing holder mounting jig is configured to be mounted to the mounting shaft when the mounting shaft of the optical fiber ferrule polishing machine is inserted into the insertion space of the insertion pipe, the exposed end portion is moved gradually outward in the radial direction along the tip inclined face against the biasing force of the coil spring, the exposed end portion is slid on an outer peripheral surface of the mounting shaft until the exposed end portion reaches the central recess, and the exposed end portion is moved inward in the radial direction toward the central recess by the biasing force of the coil spring until the exposed end portion is exposed to the central recess, and the polishing holder mounting jig is configured to be removed from the mounting shaft when the handle shaft is moved outward in the radial direction against the biasing force of the coil spring, the exposed end portion is moved outward in the radial direction from the insertion space of the insertion pipe, and the exposed end portion is retreated from the central recess.

In another example of the polishing holder mounting jig of the present invention, the polishing holder mounting jig includes a housing case installed on the outer peripheral surface of the insertion pipe, the housing case comprises; a housing space extending in the radial direction of the insertion pipe for housing a front end portion of the handle shaft of the operating rod and the coil spring; a peripheral wall surrounding the housing space; a rear end wall in which a first insertion hole for inserting the front end portion of the handle shaft is perforated; and a front end wall in which a second insertion hole for inserting the exposed end portion of the operating rod is perforated, and the coil spring is housed in the housing space in a state of being inserted into the front end portion of the handle shaft.

In another example of the polishing holder mounting jig of the present invention, an abutting flange extending outward in the radial direction of the operating rod is formed in the front end portion of the handle shaft, a front end surface of the abutting flange abuts on the peripheral wall of the insertion pipe, a front end portion of the coil spring abuts on the abutting flange, and a rear end portion of the coil spring abuts on the rear end wall of the housing case.

In another example of the polishing holder mounting jig of the present invention, the attaching plate of the polishing holder mounting jig is detachably attached in a central portion of the holder plate.

In another example of the polishing holder mounting jig of the present invention, a plurality of installation units for detachably installing a plurality of optical fiber ferrules in the optical fiber ferrule polishing holder is formed in a peripheral part of the holder plate, and when the attaching plate is attached to the holder plate, the rear end portion of the handle shaft of the polishing holder mounting jig extends outward in the radial direction from the peripheral part of the holder plate while passing through between the installation units.

In another example of the polishing holder mounting jig according to the present invention, a positioning recess or a positioning projection is formed in the top portion of the insertion pipe, and the positioning recess or the positioning projection determines an insertion position of the insertion pipe to the mounting shaft when the mounting shaft of the optical fiber ferrule polishing machine is inserted into the insertion space of the insertion pipe.

The second precondition of the present invention to solve the above problem is an optical fiber ferrule polishing holder used to polish a plurality of optical fiber ferrules.

In the second precondition of the present invention, an optical fiber ferrule polishing holder comprises: a holder plate having a predetermined area; a plurality of installation units formed in a peripheral part of the holder plate to detachably install a plurality of optical fiber ferrules; and a polishing holder mounting jig detachably attaching the optical fiber ferrule polishing holder to an optical fiber ferrule polishing machine, wherein the polishing holder mounting jig comprises: an attaching plate installed to a holder plate of the optical fiber ferrule polishing holder; an insertion pipe having an insertion space for enabling to removably insert a mounting shaft of the optical fiber ferrule polishing machine, the insertion pipe extending in a vertical direction from the attaching plate; an operating rod inserted into a through hole penetrating a peripheral wall of the insertion pipe in a radial direction, the operating rod extending outward in the radial direction from the insertion pipe; and a coil spring for biasing the operating rod inward in the radial direction of the insertion pipe, and the operating rod comprises; an exposed end portion exposed to the insertion space from an inner peripheral surface of the insertion pipe by a biasing force of the coil spring; and a handle shaft for moving the exposed end portion outward in the radial direction from the insertion space of the insertion pipe against the biasing force of the coil spring, the handle shaft being connected with the exposed end portion and extending outward in the radial direction from the exposed end portion.

In an example of the optical fiber ferrule polishing holder of the present invention, a mounting shaft of the optical fiber ferrule polishing machine has a tip inclined face inclining from the tip of the mounting shaft toward a rear side in the axial direction and a central recess spaced apart from the tip inclined face and extending toward the rear side in the axial direction, the central recess being recessed inward in the radial direction of the mounting shaft. The optical fiber ferrule polishing holder is configured to be mounted to the mounting shaft when the mounting shaft of the optical fiber ferrule polishing machine is inserted into the insertion space of the insertion pipe, the exposed end portion is moved gradually outward in the radial direction along the tip inclined face against the biasing force of the coil spring, the exposed end portion is slid on an outer peripheral surface of the mounting shaft until the exposed end portion reaches the central recess, and the exposed end portion is moved inward in the radial direction toward the central recess by the biasing force of the coil spring until the exposed end portion is exposed to the central recess, and, the polishing holder mounting jig is configured to be removed from the mounting shaft when the handle shaft is moved outward in the radial direction against the biasing force of the coil spring, the exposed end portion is moved outward in the radial direction from the insertion space of the insertion pipe, and the exposed end portion is retreated from the central recess.

In another example of the optical fiber ferrule polishing holder of the present invention, the plurality of installation units is formed in the peripheral part of the holder plate, and the attaching plate of the polishing holder mounting jig is attached to a central portion of the holder plate, and the rear end portion of the handle shaft extends from the peripheral part of the holder plate outward in the radial direction while passing through between the installation units.

By using the polishing holder mounting jig of the present invention, the exposed end portion of the operating rod exposed from the inner peripheral surface of the insertion pipe to the insertion space by the biasing force of the coil spring is exposed toward the mounting shaft of the optical fiber ferrule polishing machine, thereby the polishing holder mounting jig is mounted on the mounting shaft. Thus, it is possible to attach the optical fiber ferrule polishing holder to the optical fiber ferrule polishing machine quickly and easily by using the polishing holder mounting jig. In the polishing holder mounting jig, the operating rod is moved outward in the radial direction against the biasing force of the coil spring, and the exposed end portion of the operating rod is moved outward (moved back) in the radial direction from the insertion space of the insertion pipe, and the exposed end portion is retreated from the central recess. Thus, it is possible to remove the optical fiber ferrule polishing holder from the optical fiber ferrule polishing machine quickly and easily by using the polishing holder mounting jig.

In the polishing holder mounting jig, the mounting shaft of the optical fiber ferrule polishing machine has a tip inclined face inclining from the tip of the mounting shaft toward a rear side in an axial direction and a central recess spaced apart from the tip inclined face and extending toward the rear side in the axial direction, the central recess being recessed inward in the radial direction of the mounting shaft, the polishing holder mounting jig is configured to be mounted to the mounting shaft when the mounting shaft of the optical fiber ferrule polishing machine is inserted into the insertion space of the insertion pipe, the exposed end portion is moved gradually outward in the radial direction along the tip inclined face against the biasing force of the coil spring, the exposed end portion is slid on an outer peripheral surface of the mounting shaft until the exposed end portion reaches the central recess, and the exposed end portion is moved inward in the radial direction toward the central recess by the biasing force of the coil spring until the exposed end portion is exposed to the central recess, and the polishing holder mounting jig is configured to be removed from the mounting shaft when the handle shaft is moved outward in the radial direction against the biasing force of the coil spring, the exposed end portion is moved outward in the radial direction from the insertion space of the insertion pipe, and the exposed end portion is retreated from the central recess. Thus, when the exposed end portion of the operating rod reaches the central recess, the biasing force of the coil spring allows the exposed end portion to be moved inward in a radial direction toward the central recess and the exposed end portion is exposed to the central recess and engaged with the central recess. Therefore, it is possible to attach the polishing holder mounting jig to the mounting shaft by simply inserting the installation shaft of the optical fiber ferrule polishing machine into the insertion space of the insertion pipe. Consequently, the optical fiber ferrule polishing holder can be quickly and easily attached to the optical fiber ferrule polishing machine without requiring labor and time by using the polishing holder mounting jig In the polishing holder mounting jig, when the operating rod is moved outward in the radial direction against the biasing force of the coil spring, the exposed end portion of the operating rod is moved outward in the radial direction from the insertion space of the insertion pipe and the exposed end portion is retreated from the central recess and released from the engagement with the central recess. Therefore, it is possible to remove the polishing holder mounting jig from the mounting shaft by simply moving the exposed end portion outward in the radial direction from the insertion space of the insertion pipe against the biasing force of the coil spring. Consequently, the optical fiber ferrule polishing holder can be quickly and easily removed from the optical fiber ferrule polishing machine without requiring labor and time by using the polishing holder mounting jig.

In the polishing holder mounting jig, the polishing holder mounting jig includes the housing case installed on the outer peripheral surface of the insertion pipe, the housing case has a housing space for housing a front end portion of the handle shaft of the operating rod and the coil spring, and the coil spring is housed in the housing space in a state of being inserted into the front end portion of the handle shaft. Thus, when the exposed end portion of the operating rod reaches the central recess, the biasing force of the coil spring allows the exposed end portion to be moved inward in the radial direction toward the central recess, and the exposed end portion is exposed to the central recess and engaged with the central recess. Therefore, it is possible to attach the polishing holder mounting jig to the mounting shaft by simply inserting the installation shaft of the optical fiber ferrule polishing machine into the insertion space of the insertion pipe. Consequently, the optical fiber ferrule polishing holder can be quickly and easily attached to the optical fiber ferrule polishing machine without requiring labor and time by using the polishing holder mounting jig. In the polishing holder mounting jig, when the operating rod is moved outward in the radial direction against the biasing force of the coil spring, the exposed end portion of the operating rod is moved outward in the radial direction from the insertion space of the insertion pipe, and the exposed end portion is retreated from the central recess and released from the engagement with the central recess. Therefore, it is possible to remove the polishing holder mounting jig from the mounting shaft by simply moving the exposed end portion outward in the radial direction from the insertion space of the insertion pipe against the biasing force of the coil spring. Consequently, the optical fiber ferrule polishing holder can be quickly and easily removed from the optical fiber ferrule polishing machine without requiring labor and time by using the polishing holder mounting jig.

In the polishing holder mounting jig, the abutting flange extending outward in the radial direction of the operating rod is formed in the front end portion of the handle shaft, a front end surface of the abutting flange abuts on the peripheral wall of the insertion pipe, a front end portion of the coil spring abuts on the abutting flange, and a rear end portion of the coil spring abuts on the rear end wall of the housing case. Thus, the biasing force of the coil spring surely acts on the operating rod and allows the exposed end portion to be moved inward in the radial direction toward the central recess, and the exposed end portion is exposed to the central recess and engaged with the central recess. Therefore, it is possible to attach the polishing holder mounting jig to the mounting shaft by simply inserting the installation shaft of the optical fiber ferrule polishing machine into the insertion space of the insertion pipe. Consequently, the optical fiber ferrule polishing holder can be quickly and easily attached to the optical fiber ferrule polishing machine without requiring labor and time by using the polishing holder mounting jig.

In the polishing holder mounting jig, the attaching plate of the polishing holder mounting jig is detachably attached in the central portion of the holder plate. Thus, when a plurality of optical fiber ferrules is installed in the peripheral part of the holder plate, for example, the optical fiber ferrules can be evenly polished by the optical fiber ferrule polishing machine by using the polishing holder mounting jig attached to the central portion of the holder plate via the attaching plate.

In the optical fiber ferrule polishing jig, a plurality of installation units for detachably installing a plurality of optical fiber ferrules in the optical fiber ferrule polishing holder is formed in the peripheral part of the holder plate, and when the attaching plate is attached to the holder plate, the rear end portion of the handle shaft extends outward in the radial direction from the peripheral part of the holder plate while passing through between the installation units. Thus, when a plurality of optical fiber ferrules is installed in the peripheral part of the holder plate, the optical fiber ferrules can be evenly polished by the optical fiber ferrule polishing machine by using the polishing holder mounting jig attached to the central portion of the holder plate via the attaching plate. In the optical fiber ferrule polishing jig, when the attaching plate is attached to the holder plate, the rear end portion of the handle shaft extends outward in the radial direction from the peripheral part of the holder plate while passing through between the installation units. Thus, the rear end portion of the handle shaft is prevented from interfering with the installation units. Also, when the rear end portion of the handle shaft extending outward in the radial direction from the peripheral part of the holder plate is moved outward in the radial direction, the exposed end portion is retreated from the central recess of the mounting shaft. Therefore, the engagement of the exposed end portion with the central recess can be easily released.

In the polishing holder mounting jig, the positioning recess or the positioning projection is formed in the top portion of the insertion pipe, and the positioning recess or the positioning projection determines an insertion position of the insertion pipe to the mounting shaft when the mounting shaft of the optical fiber ferrule polishing machine is inserted into the insertion space of the insertion pipe. Thus, the insertion position of the insertion pipe with respect to the installation shaft is fixed by the positioning recess or the positioning protrusion. Therefore, the polishing holder mounting jig can be accurately attached to the mounting shaft of the optical fiber ferrule polishing machine at the mounting position and the exposed end portion of the operating rod can be accurately positioned in the central recess of the mounting shaft.

By using the optical fiber ferrule polishing holder of the present invention, the exposed end portion of the operating rod exposed from the inner peripheral surface of the insertion pipe to the insertion space by the biasing force of the coil spring is exposed toward the mounting shaft of the optical fiber ferrule polishing machine, thereby the polishing holder mounting jig is mounted on the mounting shaft. Thus, it is possible to attach the optical fiber ferrule polishing holder to the optical fiber ferrule polishing machine quickly and easily by using the polishing holder mounting jig. In the optical fiber ferrule polishing holder of the present invention, the operating rod is moved outward in the radial direction against the biasing force of the coil spring, the exposed end portion of the operating rod is moved (moved back) outward in the radial direction from the insertion space of the insertion pipe, and the exposed end portion is retreated from the central recess. Thus, it is possible to remove the optical fiber ferrule polishing holder from the optical fiber ferrule polishing machine quickly and easily by using the polishing holder mounting jig.

In the optical fiber ferrule polishing holder, the mounting shaft of the optical fiber ferrule polishing machine has a tip inclined face inclining from the tip of the mounting shaft toward a rear side in an axial direction and a central recess spaced apart from the tip inclined face and extending toward the rear side in the axial direction, the central recess being recessed inward in the radial direction of the mounting shaft, the optical fiber ferrule polishing holder is configured to be mounted to the mounting shaft when the mounting shaft of the optical fiber ferrule polishing machine is inserted into the insertion space of the insertion pipe, the exposed end portion is moved gradually outward in the radial direction along the tip inclined face against the biasing force of the coil spring, the exposed end portion is slid on an outer peripheral surface of the mounting shaft until the exposed end portion reaches the central recess, and the exposed end portion is moved inward in the radial direction toward the central recess by the biasing force of the coil spring until the exposed end portion is exposed to the central recess, and the polishing holder mounting jig is configured to be removed from the mounting shaft when the handle shaft is moved outward in the radial direction against the biasing force of the coil spring, the exposed end portion is moved outward in the radial direction from the insertion space of the insertion pipe, and the exposed end portion is retreated from the central recess. Thus, when the exposed end portion of the operating rod reaches the central recess of the mounting shaft, the biasing force of the coil spring allows the exposed end portion to be moved inward in the radial direction toward the central recess, and the exposed end portion is exposed to the central recess and engaged with the central recess. Therefore, it is possible to attach the polishing holder mounting jig to the mounting shaft by simply inserting the installation shaft of the optical fiber ferrule polishing machine into the insertion space of the insertion pipe. Consequently, the optical fiber ferrule polishing holder can be quickly and easily attached to the optical fiber ferrule polishing machine without requiring labor and time by using the polishing holder mounting jig. In the optical fiber ferrule polishing holder, the operating rod is moved outward in the radial direction against the biasing force of the coil spring, the exposed end portion of the operating rod is moved outward in the radial direction from the insertion space of the insertion pipe, and the exposed end portion is retreated from the central recess and released from the engagement with the central recess. Therefore, it is possible to remove the polishing holder mounting jig from the mounting shaft by simply moving the exposed end portion outward in the radial direction from the insertion space of the insertion pipe against the biasing force of the coil spring. Consequently, the optical fiber ferrule polishing holder can be quickly and easily removed from the optical fiber ferrule polishing machine without requiring labor and time by using the polishing holder mounting jig.

In the optical fiber ferrule polishing holder, a plurality of installation units is formed in the peripheral part of the holder plate, the attaching plate of the polishing holder mounting jig is attached to the central portion of the holder plate, and the rear end portion of the handle shaft extends from the peripheral part of the holder plate outward in the radial direction while passing through between the installation units the installation units. Thus, when a plurality of optical fiber ferrules is installed in the peripheral part of the holder plate, the optical fiber ferrules can be evenly polished by the optical fiber ferrule polishing machine by using the polishing holder mounting jig attached to the central portion of the holder plate via the attaching plate. In the optical fiber ferrule polishing holder, when the attaching plate of the polishing holder mounting jig is attached to the holder plate, the rear end portion of the handle shaft extends from the peripheral part of the holder plate outward in the radial direction while passing through between the installation units. Thus, the rear end portion of the handle shaft is prevented from interfering with the installation units. Also, when the rear end portion of the handle shaft extending outward in the radial direction from the peripheral part of the holder plate is moved outward in the radial direction, the exposed end portion retreats from the central recess of the mounting shaft. Therefore, the engagement of the exposed end portion with the central recess can be easily released.

### BRIEF DESCRIPTION OF THE DRAWINGS

FIG. 1 is a perspective view of a polishing holder mounting jig shown as an example.

FIG. 2 is a top view of the polishing holder mounting jig.

FIG. 3 is a cross-sectional view taken along line A-A in FIG. 1.

FIG. 4 is a cross-sectional view which is the same as FIG. 3 except that a handle shaft of an operating rod is moved outward in a radial direction.

FIG. 5 is a top view of an optical fiber ferrule polishing holder shown as an example.

FIG. 6 is a top view of a holder plate shown as an example.

FIG. 7 is a partially enlarged perspective view of a torus member.

FIG. 8 is a perspective view of a fixing piece shown as an example.

FIG. 9 is a partially enlarged front view of the optical fiber ferrule polishing holder when a pivoting rod is pivoted in an inclined state.

FIG. 10 is a cross-sectional view taken along line B-B in FIG. 9.

FIG. 11 is a cross-sectional view which is the same as FIG. 10 except that an optical fiber ferrule is not inserted into a ferrule insertion hole.

FIG. 12 is a cross-sectional view of the pivoting rod in a half-pivoted state.

FIG. 13 is a partially enlarged front view of the optical fiber ferrule polishing holder when the pivoting rod is pivoted to an upright state.

FIG. 14 is a cross-sectional view taken along line C-C in FIG. 13.

FIG. 15 is a side view of an optical fiber ferrule polishing machine when the optical fiber ferrule polishing holder is attached.

FIG. 16 is a cross-sectional view taken along line D-D in FIG. 15.

FIG. 17 is a perspective view of the optical fiber ferrule polishing machine during polishing.

### DETAILED DESCRIPTION OF THE INVENTION

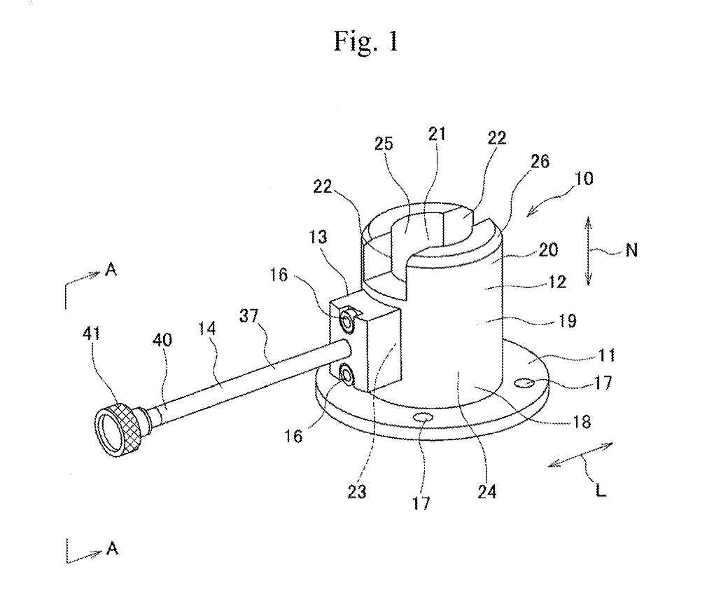

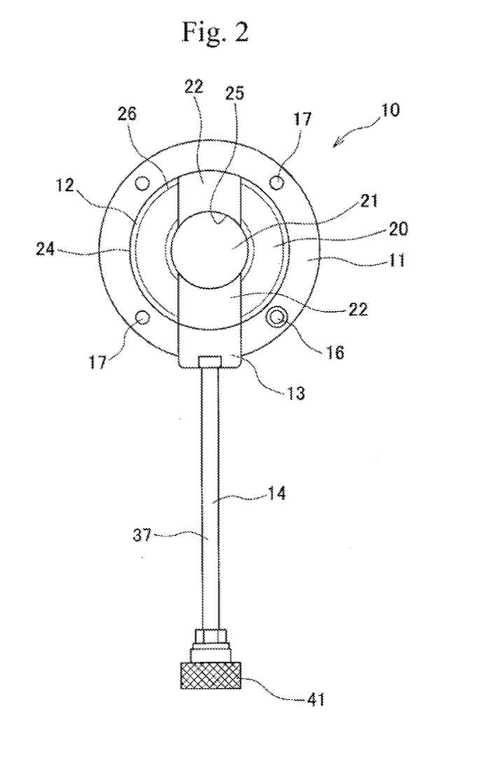

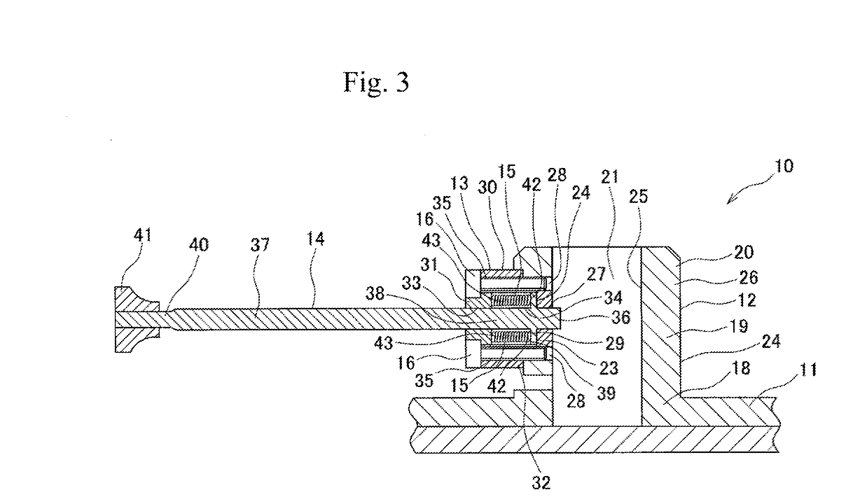

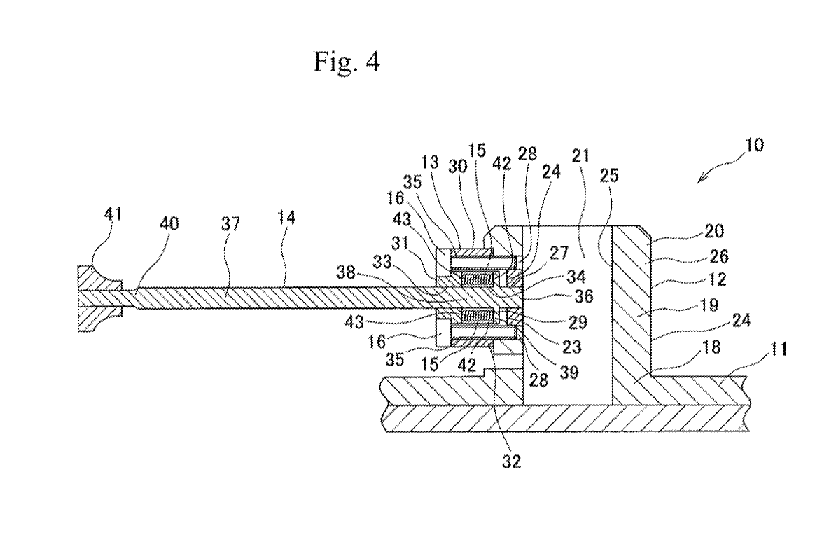

The polishing holder mounting jig according to the present invention and the optical fiber ferrule polishing holder according to the present invention will be described in detail with reference to the accompanying drawings of FIG. 1 and the like. FIG. 1 is a perspective view of the polishing holder mounting jig shown as an example. FIG. 2 is a top view of the polishing holder mounting jig and FIG. 3 is a cross-sectional view taken along line A-A in FIG. 1. FIG. 4 is a cross-sectional view which is the same as FIG. 3 except that a handle shaft of an operating rod is moved outward in a radial direction. In FIG. 1, a radial direction is indicated by an arrow L and a vertical direction is indicated by an arrow N.

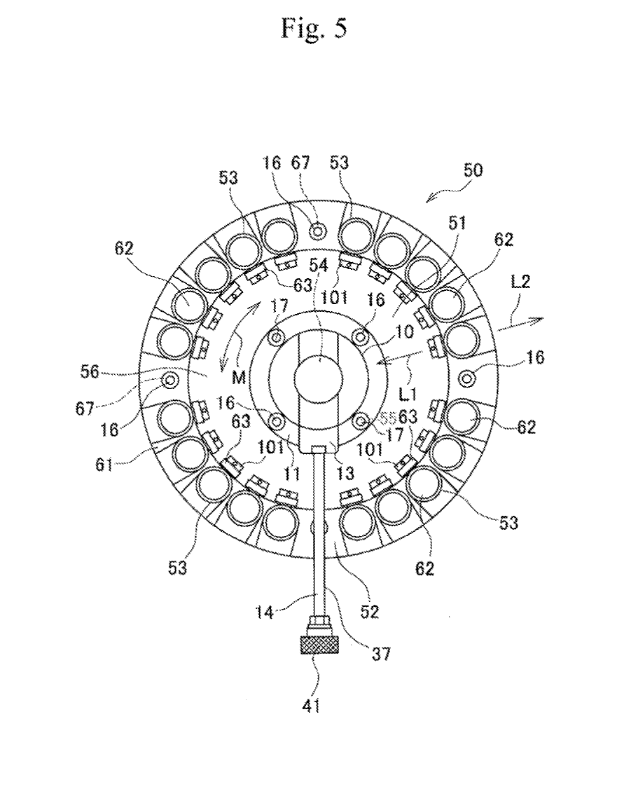

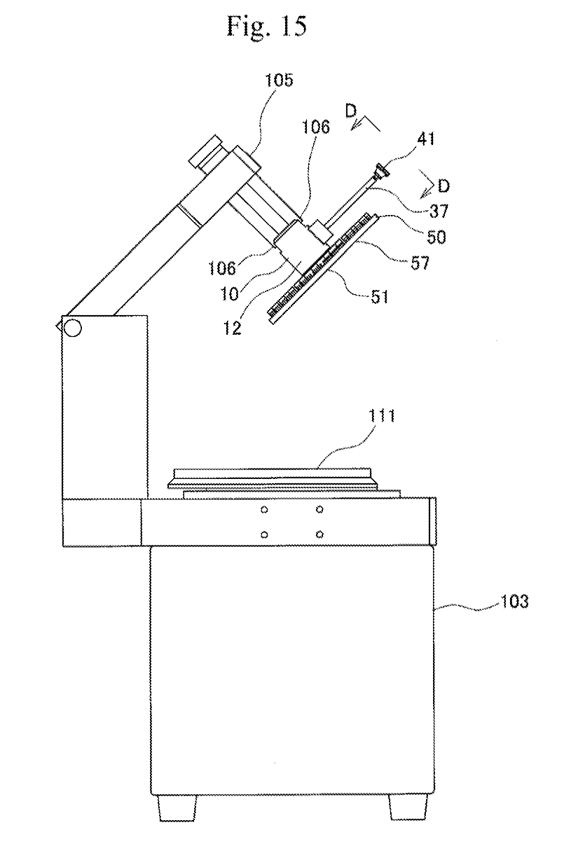

A polishing holder mounting jig 10 is detachably attached to an optical fiber ferrule polishing holder 50 (shown in FIG. 5) used for polishing optical fiber ferrules 101a. The polishing holder mounting jig 10 is used for attaching the optical fiber ferrule polishing holder 50 to an optical fiber ferrule polishing machine 103 (shown in FIG. 15). The polishing holder mounting jig 10 comprises an attaching plate 11, an insertion pipe 12, a housing case 13, an operating rod 14, and a coil spring 15.

The attaching plate 11 is made of metal such as aluminum, alloy steel, steel or synthetic resin. The attaching plate 11 is formed into an annular shape (donut shape) having a predetermined thickness. In the attaching plate 11, screw holes 17 for inserting or screwing fixing screws 16 (e.g. hexagon socket head bolts) are drilled. The attaching plate 11 is detachably attached to a later described holder plate 51 of the optical fiber ferrule polishing holder 50. The attaching plate 11 can be integrally formed with the holder plate 51 so that the attaching plate 11 is continuously connected to the holder plate 51.

The insertion pipe 12 is made of metal such as aluminum, alloy steel, steel or synthetic resin. The insertion pipe 12 is integrally formed with the attaching plate 11 and continuously connected to the attaching plate 11. The insertion pipe 12 extends straight from the attaching plate 11 in the vertical direction. The insertion pipe 12 comprises a bottom portion 18 leading to the attaching plate 11, a top portion 20 located on the opposite side of the bottom portion 18, a central portion 19 extending between the bottom portion 18 and the top portion 20, and a cylindrical insertion space 21 extending from the bottom portion 18 toward the top portion 20. In the insertion space 21, a later described mounting shaft 104 of the optical fiber ferrule polishing machine 103 is removably inserted.

On the top portion 20 of the insertion pipe 12, two positioning recesses 22 recessed in the vertical direction from the top portion 20 to the central portion 19 are formed. Alternatively, two positioning protrusions projecting upward from the top portion 20 can be formed in the top portion 20 of the insertion pipe 12. The positioning recesses 22 or the positioning protrusions determine the insertion position of the insertion pipe 12 with respect to the mounting shaft 104 when the mounting shaft 104 of the optical fiber ferrule polishing machine 103 is inserted into the insertion space 21 of the insertion pipe 12. Thus, the insertion pipe 12 is attached to a predetermined position of the mounting shaft 104.

In the central portion 19 of the insertion pipe 12, an installation recess 23 recessed inward in the radial direction is formed. In the installation recess 23, a through hole 27 and screw holes 28 are drilled. The through hole 27 penetrates a peripheral wall 26 of the insertion pipe 12 in the radial direction and extends between an outer peripheral surface 24 and an inner peripheral surface 25 of the insertion pipe 12. In the screw holes 28, the fixing screws 16 are screwed.

The housing case 13 is made of metal such as aluminum, alloy steel, steel or synthetic resin. The housing case 13 is detachably installed in the installation recess 23 formed in the outer peripheral surface 24 of the central portion 19 of the insertion pipe 12. The housing case 13 has a housing space 29 extending in the radial direction of the insertion pipe 12, peripheral walls 30 (both side walls and both end walls) surrounding the housing space 29, a vertically extending rear end wall 31, and a vertically extending front end wall 32 abutting on the installation recess 23. The housing space 29 houses a front end portion 38 (abutting flange 39) of a later described handle shaft 37 of the operating rod 14 and a coil spring 15. The rear end wall 31 has an insertion hole 33 drilled for inserting the handle shaft 37. The front end wall 32 has an insertion hole 34 drilled for inserting a later described exposed end portion 36 of the operating rod 14.

In the housing case 13, screw holes 35 are drilled to insert or screw the fixing screws 16 (e.g. hexagon socket head bolts). The screw holes 35 extend in the radial direction from the rear end wall 31 toward the front end wall 32. The housing case 13 is fixed to the peripheral wall 26 (installation recess 23) in the central portion 19 of the insertion pipe 12 in a manner that the front end wall 32 of the housing case 13 is fitted in the installation recess 23 of the insertion pipe 12 and the fixing screws 16 are inserted and screwed into the screw holes 35 of the housing case 13 until the fixing screw 16 is screwed to the screw hole 28 of the peripheral wall 26 of the insertion pipe 12.

The operating rod 14 is made of metal such as aluminum, alloy steel, steel or synthetic resin. The operating rod 14 is formed in a long rod shape extending in the radial direction. The operating rod 14 is inserted into the insertion hole 33 of the insertion pipe 12 and straightly extends outward in the radial direction from the insertion pipe 12. The operating rod 14 includes an exposed end portion 36 and a handle shaft 37. The exposed end portion 36 is exposed from the inner peripheral surface 25 to the insertion space 21 of the insertion pipe 12. The handle shaft 37 is connected to the exposed end portion 36 and extending outward in the radial direction from the exposed end portion 36.

The exposed end portion 36 is inserted into the insertion hole 34 of the front end wall 32 of the housing case 13 and slidably inserted into the through hole 27 of the insertion pipe 12. The exposed end portion 36 is moved inward in the radial direction and is retreated outward in the radial direction. The exposed end portion 36 is exposed to the insertion space 21 from the inner peripheral surface 25 of the insertion pipe 12 by being moved inward in the radial direction. The exposed end portion 36 is retreated to the through hole 27 and the installation recess 23 of the insertion pipe 12 from the insertion space 21 by being moved (moved back) outward in the radial direction.

The handle shaft 37 extends in the radial direction while a front end portion 38 of the handle shaft 37 is housed in the housing space 29 of the housing case 13. The front end portion 38 of the handle shaft 37 is slidably inserted into the insertion hole 33 which is perforated in the rear end wall 31 of the housing case 13. On the front end portion 38 of the handle shaft 37, an abutting flange 39 extending outward in the radial direction of the operating rod 14 is formed. A grippable knob 41 is attached to a rear end portion 40 of the handle shaft 37.

A coil spring 15 (compressed coil spring) is housed in the housing space 29 of the housing case 13 and the installation recess 23 of the insertion pipe 12 in a state of being inserted into the front end portion 38 of the handle shaft 37. The coil spring 15 urges the operating rod 14 (exposed end portion 36) inward in the radial direction of the insertion pipe 12. The coil spring 15 has a front end portion 42 abutting on the abutting flange 39 and a rear end portion 43 abutting on the rear end wall 31 of the housing case 13. Due to a biasing force of the coil spring 15, the front end surface of the abutting flange 39 abuts on (closely contacts) the outer peripheral surface 24 of the installation recess 23 of the insertion pipe 12 and the exposed end portion 36 of the operating rod 14 is exposed to the insertion space 21 from the inner peripheral surface 25 of the insertion pipe 12.

When the handle shaft 37 is moved (pulled) outward in the radial direction against the biasing force of the coil spring 15 by gripping the knob 41 of and the handle shaft 37, the front end portion 38 (abutting flange 39) of the handle shaft 37 is moved back (retreated) in the radial direction in the housing space 29 of the housing case 13 and the exposed end portion 36 of the operating rod 14 is moved (retreated) outward in a radial direction from the insertion space 21. Accordingly, the exposed end portion 36 is moved to the through hole 27 and the installation recess 23 of the insertion pipe 12 and retreated from the housing space 29.

When the pulling force of the handle shaft 37 outward in the radial direction is released, the front end portion 38 (abutting flange 39) of the handle shaft 37 is moved forward in the radial direction in the housing space 29 of the housing case 13 by the biasing force of the coil spring 15. Accordingly, the exposed end portion 36 of the operating rod 14 is exposed to the insertion space 21 from the inner peripheral surface 25 of the insertion pipe 12 and the exposed state is maintained.

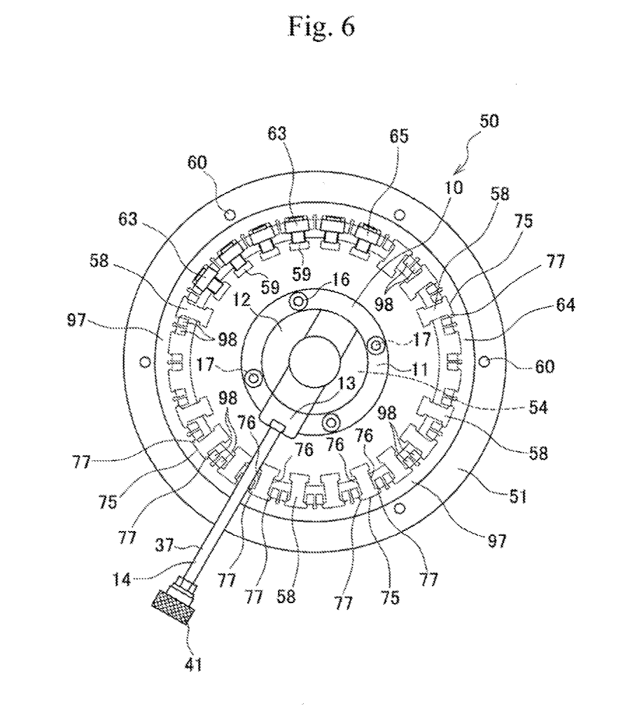

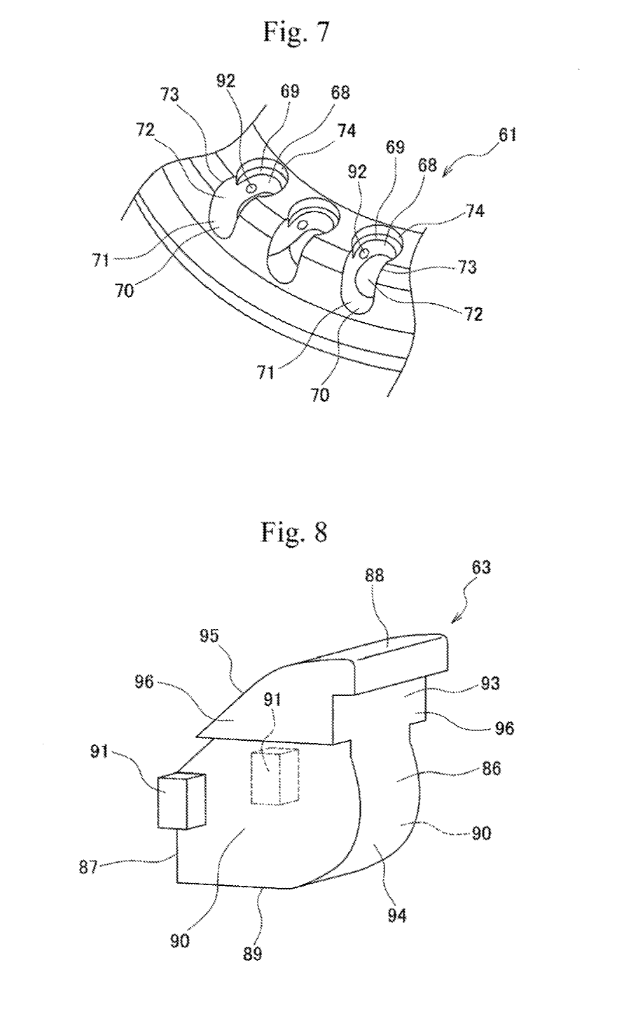

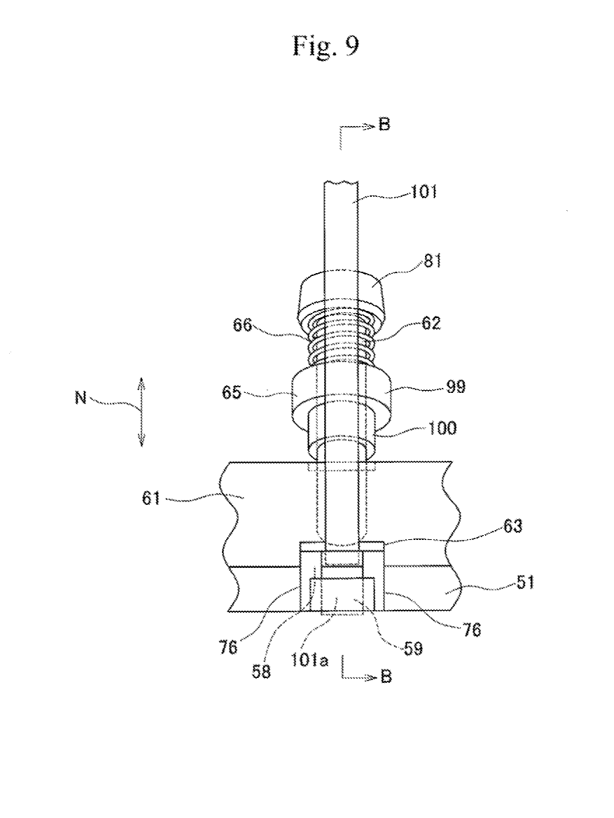

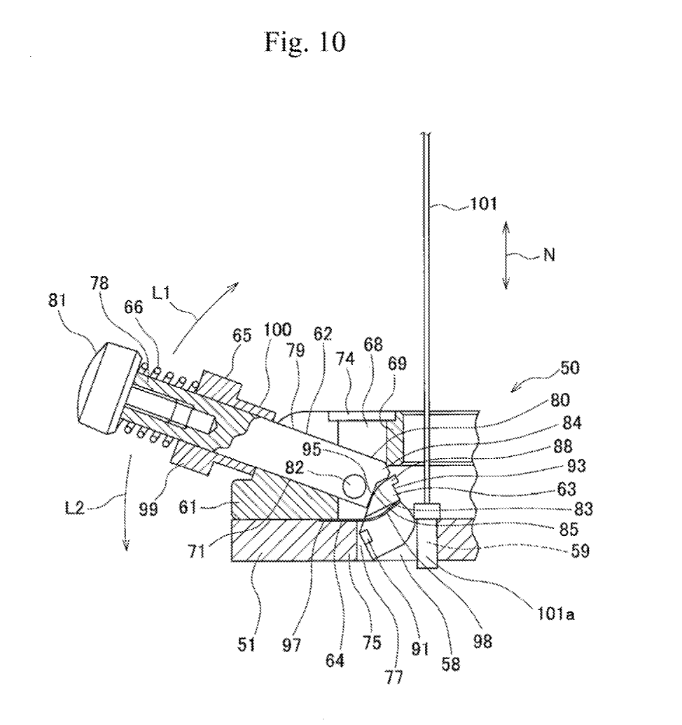

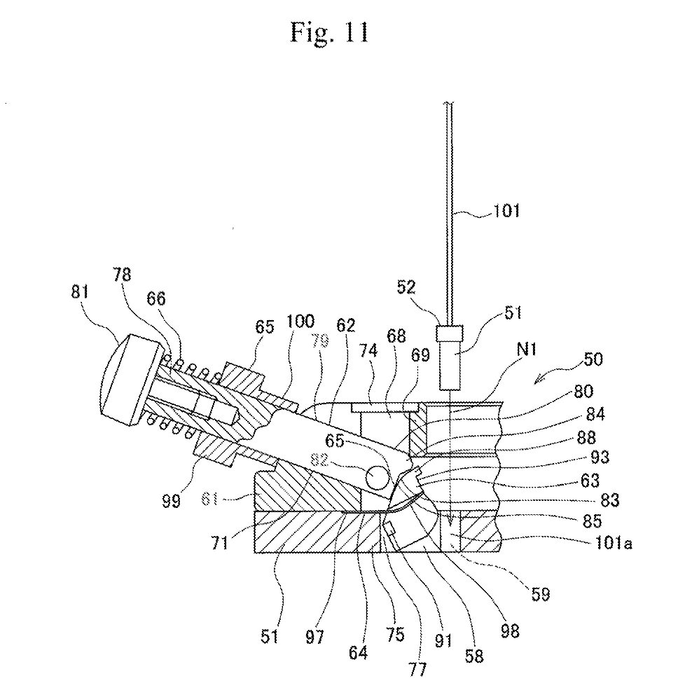

FIG. 5 is a top view of an optical fiber ferrule polishing holder 50 shown as an example. FIG. 6 is a top view of a holder plate 51 shown as an example. FIG. 7 is a partially enlarged perspective view of a torus member 61. FIG. 8 is a perspective view of a fixing piece 63 shown as an example. FIG. 9 is a partially enlarged front view of the optical fiber ferrule polishing holder 50 when a pivoting rod 62 is pivoted in an inclined state. FIG. 10 is a cross-sectional view taken along line B-B in FIG. 9. FIG. 11 is a cross-sectional view which is the same as FIG. 10 except that an optical fiber ferrule is not inserted into a ferrule insertion hole 59 of the holder plate 51. In FIG. 5, a radially inward direction (inward in the radial direction) is indicated by an arrow L1, a radially outward direction (outward in the radial direction) is indicated by an arrow L2, and a circumferential direction is indicated by an arrow M. In FIG. 9, a vertical direction is indicated by an arrow N.

The optical fiber ferrule polishing holder 50 is detachably installed to an optical fiber ferrule polishing machine 103 and used when the optical fiber ferrules 101a of the optical fibers 101 are polished by the optical fiber ferrule polishing machine 103. The optical fiber ferrule polishing holder 50 comprises a holder plate 51 (base), a plurality of installation units 53, and a polishing holder mounting jig 10. The holder plate 51 has a predetermined area and a predetermined thickness. The installation units 53 are formed on a peripheral part 52 of the holder plate 51 to detachably attach a plurality of optical fiber ferrules 101a. The polishing holder mounting jig 10 detachably attaches the polishing holder 50 to the optical fiber ferrule polishing machine 103.

The holder plate 51 is made of metal such as aluminum, alloy steel, steel or synthetic resin. The holder plate 51 is formed in a circular flat plate shape (disc shape). In a central portion 54 of the holder plate 51, screw holes 55 are drilled for screwing the fixing screws 16 (e.g. hexagon socket head bolts). In the central portion 54 of the holder plate 51, the polishing holder mounting jig 10 is attached by the fixing screws 16 in a manner that the fixing screws 16 are screwed to the screw hole 17 of the attaching plate 11 of the polishing holder mounting jig 10 and the screw hole 55. When the fixing screws 16 are removed from the screw holes 55, the polishing holder mounting jig 10 can be removed from the holder plate 51. Since a polishing plate 111 (shown in FIG. 15) of the optical fiber ferrule polishing machine 103 has a disk shape, when the holder plate 51 is formed in a circular flat plate shape (disc shape), it is possible to polish the optical fiber ferrules on the same circumference. This reduces variations in the polishing results of a plurality of optical fiber ferrules. Furthermore, a larger number of optical fiber ferrules can be installed. However, the shape of the holder plate 51 is not limited to the circular flat plate shape. The holder plate 51 can be formed in any other shapes.

In the peripheral part 52 of the holder plate 51, a plurality of installation holes 58 (installation portions) and a plurality of ferrule insertion holes 59 are formed. The installation holes 58 and the ferrule insertion holes 59 vertically penetrate a top surface 56 and an undersurface 57 of the holder plate 51. The installation holes 58 and the ferrule insertion holes 59 are annularly arranged in the peripheral part 52 of the holder plate 51. In the peripheral part 52 of the holder plate 51, screw holes 60 for screwing the fixing screws 16 (e.g. hexagon socket head bolts) are perforated.

On the peripheral part of the holder plate, a plurality of installation units 53 are formed and annularly arranged. Each of the installation units 53 comprises a torus member 61 (raised member), a plurality of pivoting rods 62 rotatably installed on the holder plate 51, a plurality of fixing pieces 63 rotatably (movably) installed on the holder plate 51, a plurality of flat springs 64 (biasing unit) installed on the holder plate 51, a plurality of slide locks 65 inserted around the pivoting rod 62, and a plurality of coil springs 66 inserted around the pivoting rod 62 to extend in the axial direction of the rod 62. The torus member 61 has a predetermined thickness and has a plano-convex shape which is convex (raised) upward from the holder plate 51.

The torus member 61 is made of metal such as aluminum, alloy steel, steel or synthetic resin. The torus member 61 is positioned on the top surface 56 of the holder plate 51 and extends annularly to form a torus (ring). In the torus member 61, screw holes 67 are drilled for inserting or screwing the fixing screws 16 (e.g. hexagon socket head bolts). The torus member 61 is fixed to the peripheral part 52 of the holder plate 51 in a manner that the fixing screws 16 are screwed to the screw holes 67 of the torus member 61 and the screw holes 60 of the holder plate 51. When the planar shape of the holder plate 51 is formed into a shape other than a circular shape, the raised member (torus member 61) is formed into a shape which surrounds the peripheral part of the holder plate 51.

As shown in FIG. 7, the torus member 61 includes annularly arranged upper openings 68, annularly arranged upright support portions 69, annularly arranged side openings 70, annularly arranged inclined support portions 71, annularly arranged openings 72 for pivoting, and annularly arranged pivoting portions 73. At the bottom of each upright support portion 69 of the torus member 61, a pair of cylindrical shaft holes 92 is drilled. In the shaft holes 92, a later described pair of shafts 82 of the pivoting rod 62 is rotatably installed.

The upper openings 68 of the torus member 61 are formed into a circular shape and open upward. In each of the upper openings 68, the pivoting rod 62 is located in an upright state. Each of the upright support portions 69 surrounds the upper opening 68 and supports a later described intermediate portion 79 of the pivoting rod 62 to support the rod 62 in the upright state. In each of the upright support portions 69, a lock hole 74 recessed downward is formed. The lock hole 74 has a diameter which is slightly larger than a diameter of the upper opening 68. When the pivoting rod 62 stands upright, a later described lower end portion 100 of the slide lock 65 enters the lock hole 74.

The side openings 70 of the torus member 61 are shaped into a circular shape and open laterally (outward in the radial direction). In each of the side openings 70, the pivoting rod 62 is located in an inclined state. Each of the inclined support portions 71 surrounds the side opening 70 and supports the pivoting rod 62 in the inclined state. Each of the openings 72 for pivoting is connected to both the upper opening 68 and the side opening 70 and inclined so that an arc from the upper opening 68 toward the side opening 70 is formed. In each of the openings 72 for pivoting, the pivoting rod 62 is pivoted inward and outward in the radial direction. Each of the pivoting portions 73 surrounds the opening 72 for pivoting. Each of the pivoting portions 73 is connected to the upright support portion 69 and the inclined support portion 71 and inclined so that an arc from the upright support portion 69 toward the inclined support portion 71 is formed.

Each of the installation holes 58 of the holder plate 51 is formed between the ferrule insertion hole 59 of the holder plate 51 and the pivoting rod 62, adjacent to the inward in the radial direction of the upright support portion 69 of the torus member 61, and located in the immediate vicinity of the torus member 61. In each of the installation holes 58, the fixing piece 63 is installed so as to be capable of pivoting (moving).

Each of the installation holes 58 includes a rear wall 75, side walls 76 (both side faces), and a pair of shaft holes 77. The rear wall 75 is located substantially right below the pivoting rod 62 and extends vertically. The side walls 76 are located on both sides of the rear wall 75 and extends vertically. The pair of shaft holes 77 are formed through the side walls 76 on the side of the rear wall 75. The shaft holes 77 are through holes penetrating the top surface 56 and the undersurface 57 of the holder plate 51 and extending in the circumferential direction (horizontal direction) from the side walls 76. The ferrule insertion holes 59 of the holder plate 51 are located inward in the radial direction with respect to the installation holes 58 so that the ferrule insertion holes 59 are adjacent to the installation holes 58.

The pivoting rods 62 are made of metal such as aluminum, alloy steel, steel or synthetic resin. The pivoting rods 62 are formed into a columnar shape which is long in the vertical direction. The pivoting rods 62 are annularly arranged along the torus member 61. The pivoting rod 62 has an upper end portion 78, a lower end portion 80 and an intermediate portion 79 located between the upper end portion 78 and the lower end portion 80. The pivoting rods 62 are adjacent to the installation holes 58 of the holder plate 51 and located outward in the radial direction with respect to the installation holes 58. The pivoting rods 62 are placed just proximally to the installation holes 58 and the ferrule insertion holes 59. The pivoting rods 62 are rotatably inserted into the upper openings 68, the openings 72 for pivoting, and the side openings 70 of the torus member 61. On the upper end portion 78 of each of the pivoting rods 62, a knob 81 is attached to grip he knob 81 when the rod 62 is rotated.

On the lower end portion 80 of each of the pivoting rods 62, a pair of cylindrical shafts 82 extending in the circumferential direction (lateral direction) is formed. On a cross-sectionally circular bottom end 83 of each of the pivoting rods 62, a pressing protrusion 84 projecting toward the fixing piece 63 is formed and a remaining surface 85 except for the pressing protrusion 84 is defined and formed. The shafts 82 are rotatably inserted into the shaft hole 92 perforated below the upright support portion 69 of the torus member 61.

Each of the pivoting rods 62 can be pivoted around the lower end portion 80 (shaft 82) inward in the radial direction in the opening 72 for pivoting of the torus member 61 so that the pivoting rod 62 stands upright from the inclined state. Alternatively, each of the pivoting rods 62 can be pivoted around the lower end portion 80 (shaft 82) outward in the radial direction in the opening 72 for pivoting of torus member 61 so that the pivoting rod 62 inclines from the standing state. The pressing protrusion 84 of the pivoting rod 62 abuts on a later described top portion 88 (inclined surface 95) of the fixing piece 63 and presses the fixing piece 63 inward in the radial direction as the rod 62 is pivoted inward in the radial direction.

Each of the fixing pieces 63 is rotatably (movably) installed (housed) in each of the installation holes 58 of the holder plate 51. The fixing pieces 63 are annularly arranged along the torus member 61. As shown in FIG. 8, the fixing piece 63 comprises a front portion 86, a rear portion 87, a top portion 88, a bottom portion 89, both side portions 90, and a pair of rotating shafts 91 (pivot shafts). The front portion 86 faces the ferrule insertion hole 59 of the holder plate 51. The rear portion 87 faces the rear wall 75 of the installation hole 58 of the holder plate 51. The top portion 88 faces the bottom end 83 of the pivoting rod 62. The bottom portion 89 is located at the bottom of the installation hole 58 of the holder plate 51. The both side portions 90 face the side walls 76 (both side surfaces) of the installation hole 58 of the holder plate 51. The pair of rotating shafts 91 extend in the circumferential direction (lateral direction) from the both side portions 90 located on the rear portion 87 side. The rotating shafts 91 are disposed in the shaft holes 77 formed in the installation holes 58 of the holder plate 51.

The front portion 86 of the fixing piece 63 has an engagement portion 93 (recessed portion) and a curved surface 94. The engagement portion 93 is recessed outward in the radial direction (rearward). The curved surface 94 is connected to the engagement portion 93 and curves toward the bottom portion 89. Instead of the curved surface 94, the front portion 86 of the fixing piece 63 can have an inclined surface which is connected to the engagement portion 93 and is inclined downward toward the bottom portion 89 (inclined toward a rear portion). A top portion 102 of the optical fiber ferrule 101a is engaged with the engagement portion 93.

The top portion 88 of each of the fixing pieces 63 has an inclined surface 95 that is gradually inclined downwardly from the front portion 86 toward a radially outward direction (rearward). The pressing protrusion 84 of the pivoting rod 62 abuts on the inclined surface 95. The both side portions 90 of the fixing piece 63 have a pair of abutment portions 96 on the side of the top portion 88. The abutment portions 96 extend (project) in the circumferential direction (lateral direction) from the both side portions 90.

The fixing pieces 63 fix the optical fiber ferrule 101a to the ferrule insertion hole 59 in a manner that each of the fixing pieces 63 is pivoted (moved) around the rotating shaft 91 inward in the radial direction in the installation hole 58 as the pivoting rod 62 is pivoted inward in the radial direction. The fixing of the optical fiber ferrule 101a is released from the ferrule insertion hole 59 by the fixing pieces 63 in a manner that each of the fixing piece 63 is pivoted (moved) around the rotating shaft 91 outward in the radial direction in the installation hole 58 as the pivoting rod 62 is pivoted outward in the radial direction.

A flat spring 64 is disposed near the area outward in the radial direction of each of the installation holes 58 of the holder plate 51. The flat spring 64 comprises a base portion 97 and a plurality of spring portions 98 connected to the base portion 97. The base portion 97 is located on the top surface 56 of the holder plate 51 extending near the area outward in the radial direction of each of the installation holes 58. The base portion 97 extends annularly along the torus member 61 to form a torus (ring). The base portion 97 is interposed between the top surface 56 of the holder plate 51 and the undersurface of the inclined supporting portion 71 of the torus member 61. The base portion 97 is fixed to the top surface 56 of the holder plate 51 in a state of being sandwiched between the holder plate 51 and the inclined support portion 71 of the torus member 61.

The spring portions 98 are located on the top surface 56 of the holder plate 51 extending between the adjacent installation holes 58. The spring portions 98 are annularly arranged along the torus member 61. In the optical fiber ferrule polishing holder 50, when the fixing pieces 63 are installed (housed) in the installation holes 58, each of the spring portions 98 is interposed between the top surface 56 of the holder plate 51 extending between the adjacent installation holes 58 and the abutment portions 96 of the both side portions 90 of the fixing piece 63, and the abutment portions 96 of the both side portions 90 of the fixing pieces 63 abut on the spring portion 98 of the flat spring 64. The spring portions 98 bias the fixing piece 63 upward (outward in the radial direction) so as to release the fixing of the optical fiber ferrule 101a from the ferrule insertion hole 59. By the biasing force, the fixing pieces 63 are pivoted (moved) outward in the radial direction.

Each of the slide lock 65 is formed into a cylindrical shape and slid in the axial direction of the rod 62 in a state of being inserted into the pivoting rod 62. The slide lock 65 has a cylindrical knob portion 99 and a cylindrical lower end portion 100. The cylindrical knob portion 99 is gripped when the slide lock 65 is slid. The cylindrical lower end portion 100 is continued just below the knob portion 99. The lower end portion 100 of the slide lock 65 has a diameter that is smaller than a diameter of the knob portion 99, slightly smaller than a diameter of the lock hole 74 of the upright support portion 69 and slightly larger than diameters of the upper opening 68, the side opening 70, and the opening 72 for pivoting of the torus member 61.

Each of the knob portions 99 of the slide lock 65 has a diameter larger than diameters of the upper opening 68, the side opening 70, and the opening 72 for pivoting of the torus member 61. The coil spring 66 is located between the upper end portion 78 (knob 81) of the pivoting rod 62 and the knob portion 99 of the slide lock 65 and extends in the axial direction of the rod 62. The coil spring 66 biases the slide lock 65 toward the bottom end of the pivoting rod 62 (downward) by its biasing force.

FIG. 10 shows a state in which the pivoting rod 62 is pivoted outward in the radial direction and the rod 62 is inclined. In such a state, the pressing force of the pressing protrusion 84 of the rod 62 does not act on the inclined surface 95 of the top portion 88 of the fixing piece 63. Therefore, the fixing piece 63 is pivoted (moved) around the rotating shaft 91 outward in the radial direction by the biasing force of the spring portion 98 of the flat spring 64. The front portion 86 and the top portion 88 of the fixing piece 63 is pivoted outward in the radial direction, and the front portion 86 and the top portion 88 are spaced away from the ferrule insertion hole 59 outward in the radial direction and the ferrule insertion hole 59 of the holder plate 51 is open.

The pivoting rod 62 is located in the side opening 70 of the torus member 61, and the pivoting rod 62 is supported in an inclined state by the inclined support portion 71 of the torus member 61. The slide lock 65 is slid toward the upper end portion 78 (knob 81) of the pivoting rod 62 against the biasing force of the coil spring 66. The lower end portion 100 of the slide lock 65 rides on the inclined support portion 71. When the pivoting rod 62 is supported in the inclined state by the inclined support portion 71 (i.e. when the pivoting rod 62 is pivoted to the inclined state), the remaining surface 85 of the bottom end 83 of the rod 62 abuts on the inclined surface 95 of the top portion 88 of the fixing piece 63.

In the optical fiber ferrule polishing holder 50, when the pivoting rod 62 is pivoted to the inclined state, the pressing protrusion 84 of the bottom end 83 of the rod 62 abuts on the top portion 88 of the fixing piece 63, and the remaining surface 85 except for the pressing protrusion 84 abuts on the inclined surface 95 of the fixing piece 63. This can prevent the fixing piece 63 from being further pivoted (moved) outward in the radial direction by the rod 62, and regulate a pivoting range of the fixing piece 63 to be moved outward in the radial direction.

In the optical fiber ferrule polishing holder 50, as shown by the arrow N1 in FIG. 11, the optical fiber ferrule 101a of the optical fiber 101 is inserted into the ferrule insertion hole 59 that is open. Then, the optical fiber ferrule 101a is put into the ferrule insertion hole 59 as shown in FIG. 10. In the optical fiber ferrule polishing holder 50, the lower end portion 100 of the slide lock 65 rides on the inclined support portion 71 against the biasing force of the coil spring 66, and the lower end portion 100 presses the inclined support portion 71 by the biasing force of the coil spring 66. Therefore, the pivoting rod 62 is supported in the inclined state by the inclined support portion 71 of the torus member 61. This prevents the rod 62 from being carelessly pivoted (moved) inward in the radial direction, and maintains the ferrule insertion hole 59 to be released from the fixed state by the fixing piece 63 as well as maintains the ferrule insertion hole 59 to be kept open. Accordingly, the optical fiber ferrule 101a can be smoothly inserted into the ferrule insertion hole 59.

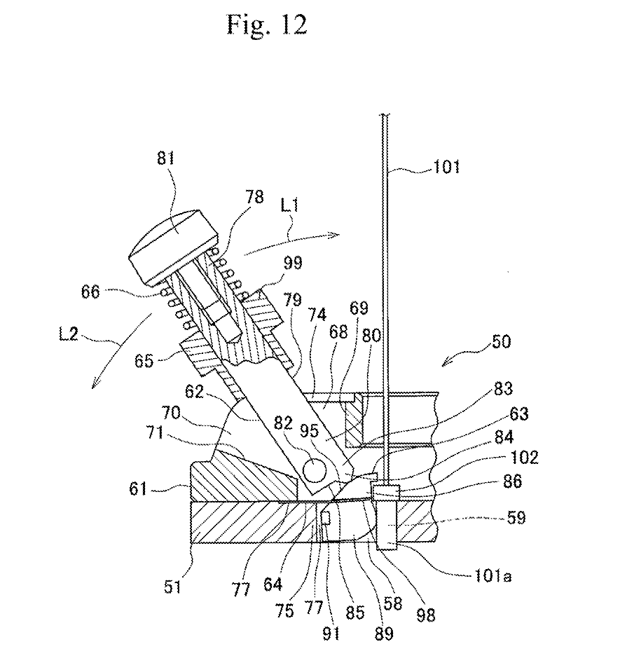

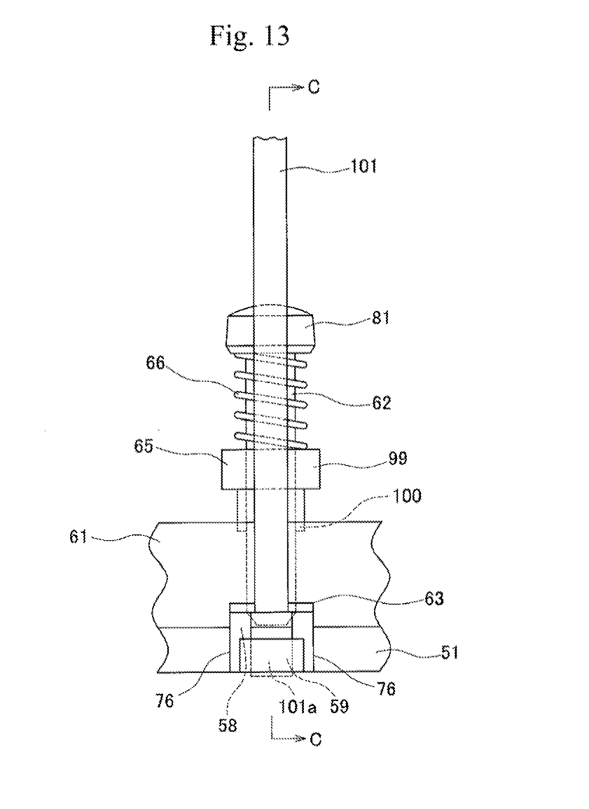

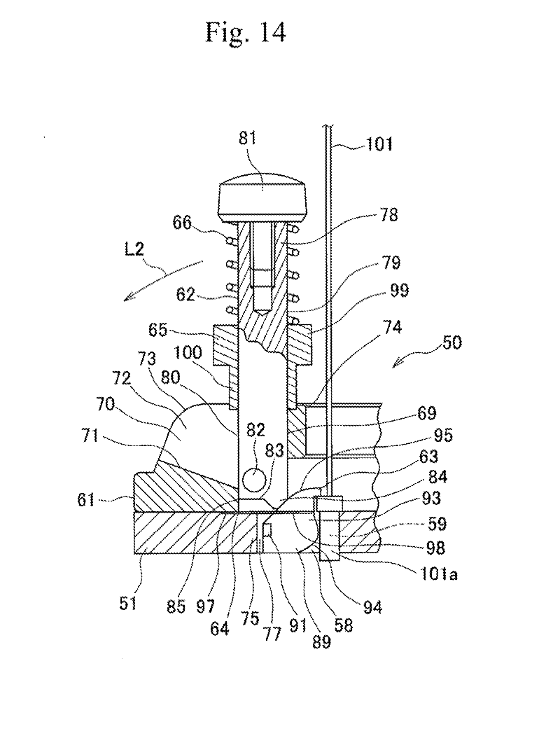

FIG. 12 is a cross-sectional view of the pivoting rod 62 in a half-pivoted state. FIG. 13 is a partially enlarged front view of the optical fiber ferrule polishing holder 50 when the pivoting rod 62 is pivoted to the upright state. FIG. 14 is a cross-sectional view taken along line C-C in FIG. 13. In FIG. 12, a radially inward direction (inward in the radial direction) is indicated by an arrow L1, and a radially outward direction (outward in the radial direction) is indicated by an arrow L2. In FIG. 14, a radially outward direction (outward in the radial direction) is indicated by an arrow L2.

The procedure to install and fix the optical fiber ferrule 101a of the optical fiber 101 in the optical fiber ferrule polishing holder 50 will be described below. First, the optical fiber ferrule 101a is inserted into the ferrule insertion hole 59 of the holder plate 51 in a state that the ferrule insertion hole 59 is open. Then, the knob 81 of the pivoting rod 62 is gripped. In such a state, the pivoting rod 62, which is in the inclined state, is pivoted inward in the radial direction as shown by the arrow L1 in FIG. 10.

When the pivoting rod 62 is pivoted inward in the radial direction, the pivoting rod 62 is pivoted around the lower end portion 80 from the side opening 70 to upper opening 68 of the torus member 61 as shown in FIG. 12, and the intermediate portion 79 of the rod 62 is moved within the opening 72 for pivoting of the torus member 61. While the lower end portion 100 of the slide lock 65 rides on the pivoting portion 73 of the torus member 61, the lower end portion 100 is slid on the pivoting portion 73. In such a state, the pivoting rod 62 is moved from the inclined support portion 71 to the upright support portion 69 of the torus member 61.

When the pivoting rod 62 is pivoted inward in the radial direction, the pressing protrusion 84 formed in the bottom end 83 of the rod 62 pushes the inclined surface 95 of the top portion 88 of the fixing piece 63, and the fixing piece 63 is gradually pivoted (moved) around the rotating shaft 91 inward in the radial direction against the biasing force of the spring portion 98 (biasing unit) of the flat spring 64. Then, the front portion 86 and the top portion 88 of the fixing piece 63 are pivoted inward in the radial direction, and the front portion 86 and the top portion 88 gradually approach the ferrule insertion hole 59.

In the optical fiber ferrule polishing holder 50, when the pivoting rod 62 is pivoted from the inclined state to the upright state, the pressing protrusion 84 of the rod 62 pushes the inclined surface 95 of the fixing piece 63 while the pressing protrusion 84 slides on the inclined surface 95. This enables the fixing piece 63 to be smoothly pivoted (moved) inward in the radial direction against the biasing force of the spring portion 98 of the flat spring 64, as well as allows the fixing piece 63 to be surely pivoted around the rotating shaft 91 by the pressing protrusion 84 of the rod 62.

When the pivoting rod 62 in a state shown in FIG. 12 is further pivoted inward in the radial direction, the rod 62 is moved within the pivoting portion 73 toward the upper opening 68 of the torus member 61. As shown in FIGS. 13 and 14, the rod 62 is moved from the pivoting portion 73 to the upright support portion 69. That means the rod 62 is pivoted from the inclined state to the upright state. As the pivoting rod 62 is pivoted from the inclined state to the upright state, the fixing piece 63 is further pivoted (moved) inward in the radial direction. Then, the front portion 86 of the fixing piece 63 is moved to the ferrule insertion hole 59.

When the pivoting rod 62 is pivoted to the upright state, the rod 62 is located in the upper opening 68 of the torus member 61. At the same time, the intermediate portion 79 of the rod 62 abuts on the upright support portion 69 of the torus member 61. This prevents the rod 62 to be further pivoted inward in the radial direction. When the pivoting rod 62 is moved to the upright support portion 69 of the torus member 61, the slide lock 65 is moved to the lower part of the rod 62 by the biasing force of the coil spring 66, and the lower end portion 100 of the slide lock 65 enters into the lock hole 74.

When the lower end portion 100 of the slide lock 65 enters into the lock hole 74, the pivoting rod 62 is fixed to the upright support portion 69 in a manner that the pivoting rod 62 cannot be pivoted further. Thereby the upright state of the rod 62 is maintained. Furthermore, the slide lock 65 is pushed to the lower part of the pivoting rod 62 by the biasing force of the coil spring 66. Accordingly, the lower end portion 100 of the slide lock 65 is maintained to be entered into the lock hole 74.

When the pivoting rod 62 stands upright in the torus member 61 and the front portion 86 of the fixing piece 63 is moved to the ferrule insertion hole 59, the bottom portion 89 of the fixing piece 63 is located on the bottom of the installation hole 58 and the top portion 102 of the optical fiber ferrule 101a is engaged with the engagement portion 93 of the front portion 86 of the fixing piece 63 as shown in FIG. 14. Since the top portion 102 of the optical fiber ferrule 101a is engaged with the engagement portion 93, the optical fiber ferrule 101a is fixed so that the optical fiber ferrule 101a cannot be moved freely in the ferrule insertion hole 59 of the holder plate 51 and the optical fiber ferrule 101a cannot be got out of the insertion hole 59.

In the optical fiber ferrule polishing holder 50, the lower end portion 100 of the slide lock 65 is maintained to be entered into the lock hole 74 by the biasing force of the coil spring 66, and the upright state of the pivoting rod 62 is also maintained. This prevents the rod 62 from being carelessly pivoted (moved) outward in the radial direction. Accordingly, the optical fiber ferrule 101a can be maintained to be fixed to the ferrule insertion hole 59 by the fixing piece 63 without being carelessly released from the fixing to the ferrule insertion hole 59.

In the optical fiber ferrule polishing holder 50, when the pivoting rod 62 is pivoted to the upright state, the top portion 102 of the optical fiber ferrule 101a is engaged with the engagement portion 93 formed in the front portion 86 of the fixing piece 63. Due to the engagement of the engagement portion 93, the optical fiber ferrule 101a is fixed so that the optical fiber ferrule 101a cannot be moved freely in the ferrule insertion hole 59 and the optical fiber ferrule 101a cannot be got out of the insertion hole 59.

In the optical fiber ferrule polishing holder 50, the optical fiber ferrule 101a is fixed to the ferrule insertion hole 59 by the fixing piece 63, which is moved together with the pivoting of the pivoting rod 62. Thus, the optical fiber ferrule 101a can be fixed by the simple operation of pivoting the pivoting rod 62. This saves labor and time to fix the optical fiber ferrule 101a to the ferrule insertion hole 59, and allows the optical fiber ferrule 101a to be simply and easily fixed to the insertion hole 59.

In the optical fiber ferrule polishing holder 50, the optical fiber ferrule 101a of the optical fiber 101 is fixed to the ferrule insertion hole 59 by the fixing piece 63. Therefore, the fixing condition of a plurality of the optical fiber ferrules 101a to the ferrule insertion holes 59 can be the same, thereby a uniform polishing can be realized for each optical fiber ferrules 101a.

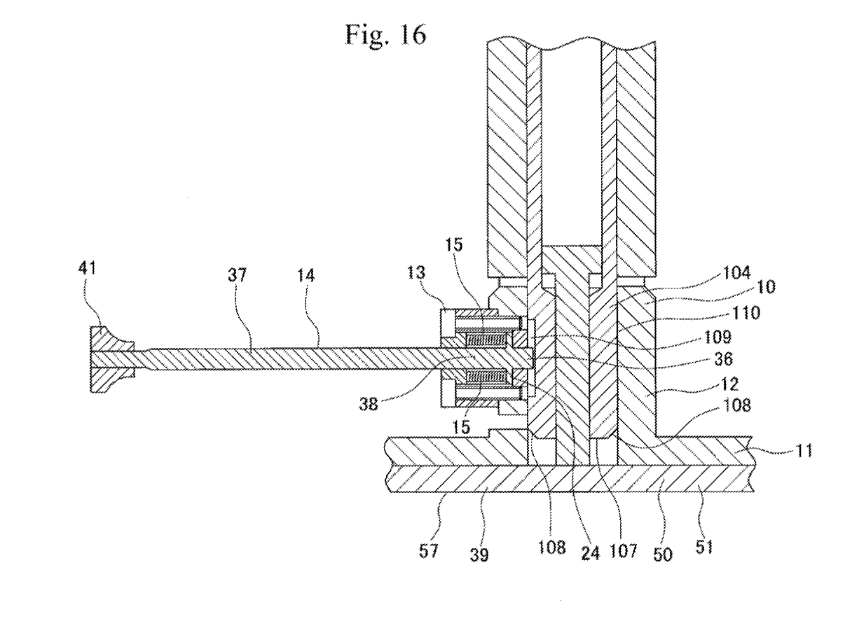

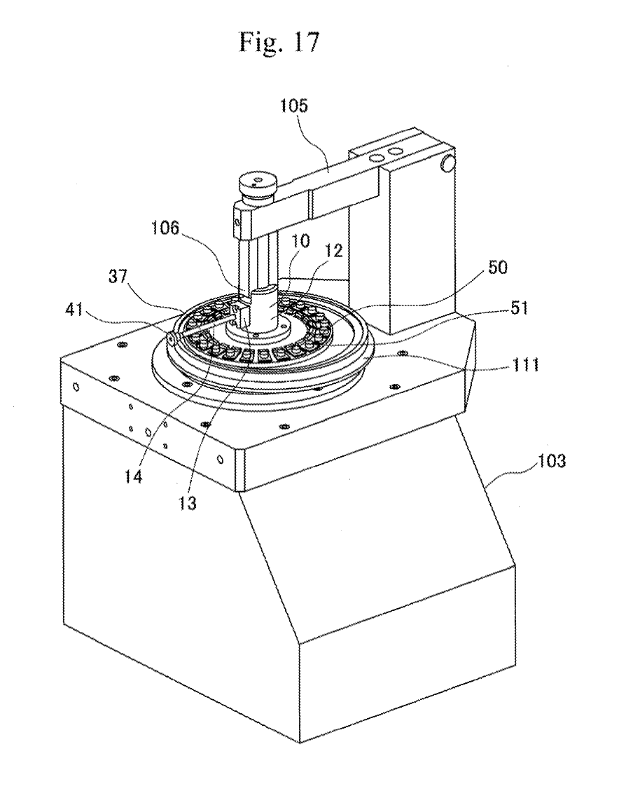

FIG. 15 is a side view of an optical fiber ferrule polishing machine 103 when the optical fiber ferrule polishing holder 50 is attached. FIG. 16 is a cross-sectional view taken along line D-D in FIG. 15. FIG. 17 is a perspective view of the optical fiber ferrule polishing machine 103 during polishing. Note that the optical fiber 101 is not shown in FIG. 15, and the optical fiber 101 and various switches are not shown in FIG. 17. After the optical fiber ferrules 101a of a plurality of optical fiber 101 are installed and fixed to the ferrule insertion holes 59, the optical fiber ferrule polishing holder 50 is attached to the mounting shaft 104 of the optical fiber ferrule polishing machine 103. The procedure to attach the optical fiber ferrule polishing holder 50 to the mounting shaft 104 of the optical fiber ferrule polishing machine 103 will be described below.

The mounting shaft 104 of the optical fiber ferrule polishing machine 103 is provided on a pivot arm 105 of the optical fiber ferrule polishing machine 103. The pivot arm 105 is pivoted in the vertical direction of the optical fiber ferrule polishing machine 103.

The pivot arm 105 is provided with the positioning protrusion 106 to which the positioning recess 22 of the top portion 20 of the insertion pipe 12 enters.

The optical fiber ferrule polishing machine 103 comprises an impact absorption function using air pressure or oil pressure, and the mounting shaft 104 is pushed forward in the axial direction by the impact absorption function. As shown in FIG. 16, the mounting shaft 104 has a tip inclined face 108 and a central recess 109. The tip inclined face 108 inclines from the tip 107 toward a rear side of the mounting shaft 104 in an axial direction of the mounting shaft 104. The central recess 109 is spaced apart from the tip inclined face 108 and extends toward the rear side in the axial direction. The central recess 109 is recessed inward in the radial direction of the mounting shaft 104.

While the positioning recess 22 of the top portion 20 of the insertion pipe 12 is aligned to the positioning protrusion 106 of the pivot arm 105, the tip 107 of the mounting shaft 104 of the optical fiber ferrule polishing machine 103 is disposed in the insertion space 21 of the insertion pipe 12 of the polishing holder mounting jig 10 which is attached to the central portion 54 of the optical fiber ferrule polishing holder 50. The positioning protrusion 106 enters the positioning recess 22, and the tip 107 of the mounting shaft 104 is inserted into the insertion space 21 of the insertion pipe 12. When the positioning protrusion 106 enters the positioning recess 22, the insertion position of the insertion pipe 12 to mounting shaft 104 is determined. Thereby, the insertion pipe 12 is mounted at the predetermined position of the mounting shaft 104.

When the tip 107 of the mounting shaft 104 is inserted into the insertion space 21, the tip inclined face 108 of the mounting shaft 104 abuts on the exposed end portion 36 of the operating rod 14 since the exposed end portion 36 is exposed to the insertion space 21 from the inner peripheral surface 25 of the insertion pipe 12. When the mounting shaft 104 is gradually inserted into the insertion space 21 of the insertion pipe 12, the exposed end portion 36 of the operating rod 14 is pushed by the tip inclined face 108 of the mounting shaft 104 against the biasing force of the coil spring 15. Thus, the front end portion 38 (abutting flange 39) of the handle shaft 37 is moved back (retreated) in the radial direction in the housing space 29 of the housing case 13. At the same time, the exposed end portion 36 is gradually moved back (retreats) outward in the radial direction along the inclination of the tip inclined face 108 of the mounting shaft 104. Therefore, the exposed end portion 36 is moved to the through hole 27 and the installation recess 23 of the insertion pipe 12.

In the process where the mounting shaft 104 is inserted into the insertion space 21 of the insertion pipe 12, the tip of the exposed end portion 36 of the operating rod 14 is slid on the outer peripheral surface 110 of the mounting shaft 104. At the same time, the exposed end portion 36 is moved to the central recess 109 of the mounting shaft 104. When the exposed end portion 36 of the operating rod 14 is moved along the outer peripheral surface 110 of the mounting shaft 104 to the central recess 109, the exposed end portion 36 is advanced (stepped forward) inward in the radial direction by the biasing force of the coil spring 15. Thus, the exposed end portion 36 is exposed in the insertion space 21 of the insertion pipe 12. Therefore, the exposed end portion 36, which is exposed in the insertion space 21, is also exposed in the central recess 109 of the mounting shaft 104. Thereby the exposed end portion 36 is engaged with the central recess 109 of the mounting shaft 104. As the exposed end portion 36 is engaged with the central recess 109, the polishing holder mounting jig 10 can be mounted to the mounting shaft 104 of the optical fiber ferrule polishing machine 103. Accordingly, the optical fiber ferrule polishing holder 50 is attached to the optical fiber ferrule polishing machine 103.

After the optical fiber ferrule polishing holder 50 is attached to the optical fiber ferrule polishing machine 103, the pivot arm 105 of the optical fiber ferrule polishing machine 103 is pivoted to a polishing plate 111. Thus, the undersurface 57 of the holder plate 51 is abutted on the polishing plate 111 of the optical fiber ferrule polishing machine 103. When the optical fiber ferrule polishing machine 103 is operated, the optical fiber ferrules 101a installed and fixed to the optical fiber ferrule polishing holder 50 are polished.

In the polishing holder mounting jig 10, when the exposed end portion 36 of the operating rod 14 reaches the central recess 109, the exposed end portion 36 is moved inward in the radial direction to the central recess 109 by the biasing force of the coil spring 15. Thus, the exposed end portion 36 is exposed in the central recess 109, and the exposed end portion 36 is engaged with the central recess 109. Therefore, it is possible to attach the polishing holder mounting jig 10 to the mounting shaft 104 of the optical fiber ferrule polishing machine 103 by simply inserting the mounting shaft 104 into the insertion space 21 of the insertion pipe 12. Accordingly, the optical fiber ferrule polishing holder 50 can be quickly and easily attached to the optical fiber ferrule polishing machine 103 without requiring labor and time by using the polishing holder mounting jig 10. As a result, the optical fiber ferrules 101a can be polished efficiently in a short time by the optical fiber ferrule polishing machine 103.

After the optical fiber ferrules 101a are polished by the optical fiber ferrule polishing machine 103, the optical fiber ferrule polishing holder 50 is removed from optical fiber ferrule polishing machine 103. The procedure to remove the optical fiber ferrule polishing holder 50 from the optical fiber ferrule polishing machine 103 will be described below.

The handle shaft 37 is moved outward in the radial direction (pulled) against the biasing force of the coil spring 15 by holding the knob 41 of and the handle shaft 37 of the operating rod 14. When the handle shaft 37 is moved outward in the radial direction, the front end portion 38 (abutting flange 39) of the handle shaft 37 is moved back (retreated) in the radial direction in the housing space 29 of the housing case 13, and the exposed end portion 36 of the operating rod 14 is moved (retreated) outward in a radial direction from the insertion space 21. Thus, the exposed end portion 36 is moved to the through hole 27 and the installation recess 23 of the insertion pipe 12. Accordingly, the exposed end portion 36 is retreated from the central recess 109.

The exposed end portion 36 of the operating rod 14 is moved outward in the radial direction from the insertion space 21 of the insertion pipe 12. Thus, the exposed end portion 36 is flush with the inner peripheral surface 25 of the insertion space 21 or the exposed end portion 36 is retracted outward in the radial direction from the inner peripheral surface 25. Thereby the engagement between the exposed end portion 36 with the central recess 109 of the mounting shaft 104 is released, the polishing holder mounting jig 10 can be removed from the mounting shaft 104. While the handle shaft 37 is moved outward in the radial direction against the biasing force of the coil spring 15, the optical fiber ferrule polishing holder 50 is removed from the optical fiber ferrule polishing machine 103, thereby the polishing holder mounting jig 10 is removed from the mounting shaft 104.

In the polishing holder mounting jig 10, when the operating rod 14 is moved outward in the radial direction against the biasing force of the coil spring 15, the exposed end portion 36 of the operating rod 14 is moved outward in the radial direction from the insertion space 21 of the insertion pipe 12, and the exposed end portion 36 is retreated from the central recess 109 and released from the engagement with the central recess 109. Therefore, it is possible to remove the polishing holder mounting jig 10 from the mounting shaft 104 by simply moving the exposed end portion 36 outward in the radial direction from the insertion space 21 of the insertion pipe 12 against the biasing force of the coil spring 15. Accordingly, the optical fiber ferrule polishing holder 50 can be quickly and easily removed from the optical fiber ferrule polishing machine 103 without requiring labor and time by using the polishing holder mounting jig 10.

After the optical fiber ferrule polishing holder 50 is removed from the optical fiber ferrule polishing machine 103, the optical fiber ferrules 101a that are polished are pulled out from the ferrule insertion holes 59 of the optical fiber ferrule polishing holder 50. The procedure to pull out the optical fiber ferrule 101a of the optical fiber 101 from the ferrule insertion hole 59 will be described below. The knob portion 99 of the slide lock 65 inserted into the pivoting rod 62, which is in the upright state, is gripped, and the slide lock 65 is moved towards the upper end portion 78 of the rod 62 against the biasing force of the coil spring 66. Thereby the lower end portion 100 of the slide lock 65 is drawn from the lock hole 74. Then, while the knob portion 99 is gripped, the knob 81 of the pivoting rod 62 is also gripped, and the pivoting rod 62 which is in the upright state is pivoted outward in the radial direction as shown by arrow L2 in FIG. 14.

When the pivoting rod 62 is pivoted outward in the radial direction, the rod 62 is pivoted around the lower end portion 80 from the upper opening 68 of the torus member 61 to the side opening 70, and the upper end portion 78 and the intermediate portion 79 of the rod 62 are moved within the opening 72 for pivoting of the torus member 61. While the lower end portion 100 of the slide lock 65 rides on the pivoting portion 73 of the toms member 61, the lower end portion 100 is slid on the pivoting portion 73. In such a state, the pivoting rod 62 is moved from the upright support portion 69 to the inclined support portion 71 of the torus member 61.

When the pivoting rod 62 is pivoted outward in the radial direction, the pressing protrusion 84 formed in the bottom end 83 of the rod 62 is moved upward on the surface 95 of the top portion 88 of the fixing piece 63, and the fixing piece 63 is gradually pivoted (moved) around the rotating shaft 91 outward in the radial direction by the biasing force of the spring portion 98 (biasing unit) of the flat spring 64. Thus, the front portion 86 and the top portion 88 of the fixing piece 63 are pivoted outward in the radial direction, and the front portion 86 and the top portion 88 are gradually spaced away from the ferrule insertion hole 59 (see FIG. 12).

When the pivoting rod 62 is further pivoted outward in the radial direction, the rod 62 is moved toward the side opening 70 of the torus member 61 within the pivoting portion 73, and the rod 62 is moved from the pivoting portion 73 to the inclined support portion 71. Thus, the rod 62 is pivoted from the upright state to the inclined state. As the rod 62 is pivoted from the upright state to the inclined state, the fixing piece 63 is further pivoted outward in the radial direction, and the front portion 86 of the fixing piece 63 is spaced away from the ferrule insertion hole 59.

When the pivoting rod 62 is pivoted to the incline state, the rod 62 is located in the side opening 70 of the torus member 61. At the same time, the intermediate portion 79 of the rod 62 abuts on the inclined support portion 71 of the torus member 61. This prevents the rod 62 to be further pivoted outward in the radial direction. When the pivoting rod 62 is moved to the inclined support portion 71 of the torus member 61, the bottom portion 89 of the fixing piece 63 is spaced away upward from the bottom of the installation hole 58. At the same time, the engagement portion 93 of the front portion 86 of the fixing piece 63 is spaced outward in the radial direction from the top portion 102 of the optical fiber ferrule 101a. Thereby the fixing between the ferrule insertion hole 59 of the holder plate 51 and the optical fiber ferrule 101a is released (shown in FIG. 10).

After the optical fiber ferrule 101a is released from the fixing with the ferrule insertion hole 59, the optical fiber ferrule 101a is pulled from the insertion hole 59. In the optical fiber ferrule polishing holder 50, the biasing force of the spring portion 98 of the flat spring 64 maintains the pivoted (moved) state of the fixing piece 63 as well as maintains the ferrule insertion hole 59 to be kept open. Accordingly, the optical fiber ferrule 101a of the optical fiber can be smoothly inserted into the ferrule insertion hole 59, and the optical fiber ferrule 101a can be smoothly removed from the ferrule insertion hole 59.

In the optical fiber ferrule polishing holder 50, as the pivoting rod 62 is pivoted from the upright state to the inclined state (pivoted outward in the radial direction), the fixing piece 63 is pivoted outward in the radial direction by the biasing force of the spring portion 98 (biasing unit) of the flat spring 64. Thus, the engagement portion 93 of the fixing piece 63 is disengaged from the top portion 102 of the optical fiber ferrule 101a, thereby the optical fiber ferrule 101a is released from the fixing due to the fixing piece 63. Accordingly, a simple operation of pivoting the pivoting rod 62 realizes the release of the optical fiber ferrule 101a from the fixing, which is made by the fixing piece 63, with the insertion hole 59. This saves labor and time and allows the optical fiber ferrule 101a to be simply and easily released from the fixing with the insertion hole 59. In the optical fiber ferrule polishing holder 50, the biasing force of the flat spring 64 maintains the moving state of the fixing piece 63 as well as maintains the open state of the ferrule insertion hole 59. Therefore, the optical fiber ferrule 101a of the optical fiber 101 can be inserted into the insertion hole 59 smoothly, and the optical fiber ferrule 101a can be removed smoothly from the insertion hole 59.

Note that in the optical fiber ferrule polishing holder 50, when the attaching plate 11 of the polishing holder mounting jig 10 is attached to the holder plate 51, the rear end portion 40 of the handle shaft 37 extends from the peripheral part 52 of the holder plate 51 outward in the radial direction while passing through between the installation units 53 (pivoting rods 62) annularly arranged. Therefore, the rear end portion 40 of the handle shaft 37 does not interfere the installation unit 53 (pivoting of the pivoting rod 62). By the installation unit 53 (pivoting of the pivoting rod 62), the optical fiber ferrules 101a of a plurality of optical fibers 101 can be installed in the peripheral part 52 of the holder plate 51. When the rear end portion 40 of the handle shaft 37, which extends outward in the radial direction from the peripheral part 52 of the holder plate 51, is moved outward in the radial direction, the exposed end portion 36 is retreated from the recess 109 of the mounting shaft 104. Therefore, the engagement between the central recess 109 and the exposed end portion 36 can be easily released.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

While the invention has been particularly shown and described with respect to preferred embodiments thereof, it should be understood by those skilled in the art that the foregoing and other changes in form and detail may be made therein without departing from the sprit and scope of the invention as defined in the appended claims.

### DESCRIPTION OF THE REFERENCE NUMERALS

10 polishing holder mounting jig
11 attaching plate
12 insertion pipe
13 housing case
14 operating rod
15 coil spring (biasing unit)
16 fixing screw
17 screw hole
18 bottom portion
19 central portion
20 top portion
21 insertion space
22 positioning recess
23 installation recess
24 outer peripheral surface
25 inner peripheral surface
26 peripheral wall
27 through hole
28 screw hole
29 housing space
30 peripheral wall
31 rear end wall
32 front end wall
33 insertion hole
34 insertion hole
35 screw hole
36 exposed end portion
37 handle shaft
38 front end portion
39 abutting flange
40 rear end portion
41 knob
42 front end portion
43 rear end portion
50 optical fiber ferrule polishing holder
51 holder plate
52 peripheral part
53 installation unit
54 central portion
55 screw hole
56 top surface
57 undersurface
58 installation hole
59 ferrule insertion hole
60 screw hole
60 torus member (raised member)
62 pivoting rod
63 fixing piece
64 flat spring (biasing unit)
65 slide lock
66 coil spring (biasing unit)
67 screw hole
68 upper opening
69 upright support portion
70 side opening
71 inclined support portion
72 opening for pivoting
73 pivoting portion
74 lock hole
75 rear wall
76 side wall
77 shaft hole
78 upper end portion
79 intermediate portion
80 lower end portion
81 knob
82 shaft
83 bottom end
84 pressing protrusion
85 remaining surface
86 front portion
87 rear portion
88 top portion
89 bottom portion
90 both side portions
91 rotating shaft
92 shaft hole
93 engagement portion
94 curved surface
95 inclined surface
96 abutment portion
97 base portion
98 spring portion
99 knob
100 lower end portion
101 optical fiber
101a optical fiber ferrule
102 top portion
103 optical fiber ferrule polishing machine
104 mounting shaft
105 pivot arm
106 positioning protrusion
107 tip
108 tip inclined face
109 central recess
110 outer peripheral surface
111 polishing plate

What is claimed is:

1. A polishing holder mounting jig for detachably attaching an optical fiber ferrule polishing holder used to polish an optical fiber ferrule to an optical fiber ferrule polishing machine, the polishing holder mounting jig comprising;
an attaching plate attached to a holder plate of the optical fiber ferrule polishing holder;
an insertion pipe having an insertion space for enabling to removably insert a mounting shaft of the optical fiber ferrule polishing machine, the insertion pipe extending in a vertical direction from the attaching plate;
an operating rod inserted into a through hole penetrating a peripheral wall of the insertion pipe in a radial direction, the operating rod extending outward in the radial direction from the insertion pipe; and
a coil spring for biasing the operating rod inward in the radial direction of the insertion pipe, wherein
the operating rod comprises;
an exposed end portion exposed from an inner peripheral surface of the insertion pipe to the insertion space by a biasing force of the coil spring; and
a handle shaft for moving the exposed end portion outward in the radial direction from the insertion space of the insertion pipe against the biasing force of the coil spring, the handle shaft being connected with the exposed end portion and extending outward in the radial direction from the exposed end portion.

2. The polishing holder mounting jig according to claim 1, wherein
the mounting shaft of the optical fiber ferrule polishing machine has a tip inclined face inclining from a tip of the mounting shaft toward a rear side in an axial direction and a central recess spaced apart from the tip inclined face and extending toward the rear side in the axial direction, the central recess being recessed inward in the radial direction of the mounting shaft,
the polishing holder mounting jig is configured to be mounted to the mounting shaft when the mounting shaft of the optical fiber ferrule polishing machine is inserted into the insertion space of the insertion pipe, the exposed end portion is moved gradually outward in the radial direction along the tip inclined face against the biasing force of the coil spring, the exposed end portion is slid on an outer peripheral surface of the mounting shaft until the exposed end portion reaches the central recess, and the exposed end portion is moved inward in the radial direction toward the central recess by the biasing force of the coil spring until the exposed end portion is exposed to the central recess, and
the polishing holder mounting jig is configured to be removed from the mounting shaft when the handle shaft is moved outward in the radial direction against the biasing force of the coil spring, the exposed end portion is moved outward in the radial direction from the insertion space of the insertion pipe, and the exposed end portion is retreated from the central recess.

3. The polishing holder mounting jig according to claim 2, wherein
the polishing holder mounting jig includes a housing case installed on the outer peripheral surface of the insertion pipe,
the housing case comprises;
a housing space extending in the radial direction of the insertion pipe for housing a front end portion of the handle shaft of the operating rod and the coil spring;
a peripheral wall surrounding the housing space;
a rear end wall in which a first insertion hole for inserting the front end portion of the handle shaft is perforated; and
a front end wall in which a second insertion hole for inserting the exposed end portion of the operating rod is perforated, and
the coil spring is housed in the housing space in a state of being inserted into the front end portion of the handle shaft.

4. The polishing holder mounting jig according to claim 3, wherein
an abutting flange extending outward in the radial direction of the operating rod is formed in the front end portion of the handle shaft,
a front end surface of the abutting flange abuts on the peripheral wall of the insertion pipe,
a front end portion of the coil spring abuts on the abutting flange, and
a rear end portion of the coil spring abuts on the rear end wall of the housing case.

5. The polishing holder mounting jig according to claim 1, wherein
the attaching plate of the polishing holder mounting jig is detachably attached in a central portion of the holder plate.

6. The polishing holder mounting jig according to claim 5, wherein
a plurality of installation units for detachably installing a plurality of optical fiber ferrules in the optical fiber ferrule polishing holder is formed in a peripheral part of the holder plate, and
when the attaching plate is attached to the holder plate, the rear end portion of the handle shaft of the polishing holder mounting jig extends outward in the radial direction from the peripheral part of the holder plate while passing through between the installation units.

7. The polishing holder mounting jig according to claim 1, wherein
a positioning recess or a positioning projection is formed in a top portion of the insertion pipe, and
the positioning recess or the positioning projection determines an insertion position of the insertion pipe to the mounting shaft when the mounting shaft of the optical fiber ferrule polishing machine is inserted into the insertion space of the insertion pipe.

8. An optical fiber ferrule polishing holder used to polish an optical fiber ferrule, the optical fiber ferrule polishing holder comprising;
a holder plate having a predetermined area;
a plurality of installation units formed in a peripheral part of the holder plate to detachably install a plurality of optical fiber ferrules; and
a polishing holder mounting jig for detachably attaching the optical fiber ferrule polishing holder to an optical fiber ferrule polishing machine, wherein
the polishing holder mounting jig comprises;
an attaching plate installed to the holder plate of the optical fiber ferrule polishing holder;
an insertion pipe having an insertion space for enabling to removably insert a mounting shaft of the optical fiber ferrule polishing machine, the insertion pipe extending in a vertical direction from the attaching plate;
an operating rod inserted into a through hole penetrating a peripheral wall of the insertion pipe in a radial direction, the operating rod extending outward in the radial direction from the insertion pipe; and
a coil spring for biasing the operating rod inward in the radial direction of the insertion pipe,
the operating rod comprises;
an exposed end portion exposed from an inner peripheral surface of the insertion pipe to the insertion space by a biasing force of the coil spring; and
a handle shaft for moving the exposed end portion outward in the radial direction from the insertion space of the insertion pipe against the biasing force of the coil spring, the handle shaft being connected with the exposed end portion and extending outward in the radial direction from the exposed end portion.

9. The optical fiber ferrule polishing holder according to claim 8, wherein
the mounting shaft of the optical fiber ferrule polishing machine has a tip inclined face inclining from a tip of the mounting shaft toward a rear side in an axial direction and a central recess spaced apart from the tip inclined face and extending toward the rear side in the axial direction, the central recess being recessed inward in the radial direction of the mounting shaft,
the polishing holder mounting jig is configured to be mounted to the mounting shaft when the mounting shaft of the optical fiber ferrule polishing machine is inserted into the insertion space of the insertion pipe, the exposed end portion is moved gradually outward in the axial direction along the tip inclined face against the biasing force of the coil spring, the exposed end portion is slid on an outer peripheral surface of the mounting shaft until the exposed end portion reaches the central recess, and the exposed end portion is moved inward in the radial direction toward the central recess by a biasing force of the coil spring until the exposed end portion is exposed to the central recess, and
the polishing holder mounting jig is configured to be removed from the mounting shaft when the handle shaft is moved outward in the radial direction against the biasing force of the coil spring, the exposed end portion is moved outward in the radial direction from the insertion space of the insertion pipe, and the exposed end portion is retreated from the central recess.

10. The optical fiber ferrule polishing holder according to claim 9, wherein
the plurality of installation units is formed in the peripheral part of the holder plate,
the attaching plate of the polishing holder mounting jig is attached to a central portion of the holder plate, and
a rear end portion of the handle shaft extends from the peripheral part of the holder plate outward in the radial direction while passing through between the installation units.
